(19) United States
(12) Patent Application Publication
(10) Pub. No.: US 2023/0077637 A1
(43) Pub. Date: Mar. 16, 2023

(54) ELECTRODE STRUCTURE, SECONDARY BATTERY, BATTERY PACK, AND VEHICLE

(71) Applicant: KABUSHIKI KAISHA TOSHIBA, Tokyo (JP)

(72) Inventors: Tomoko SUGIZAKI, Kawasaki (JP); Kenya UCHIDA, Yokohama (JP); Kazuomi YOSHIMA, Yokohama (JP); Tomoe KUSAMA, Tokyo (JP); Tetsuya SASAKAWA, Yokohama (JP)

(73) Assignee: KABUSHIKI KAISHA TOSHIBA, Tokyo (JP)

(21) Appl. No.: 17/668,662

(22) Filed: Feb. 10, 2022

(30) Foreign Application Priority Data
Sep. 15, 2021 (JP) 2021-150365

(51) Int. Cl. H01M 50/44; H01M 50/414; H01M 50/489

(52) U.S. Cl. CPC H01M 50/44; H01M 50/414; H01M 50/489; H01M 2220/20

(57) ABSTRACT

According to one embodiment, an electrode structure is provided. The electrode structure includes: the current collector; the active material-containing layer provided on at least one surface of the current collector; and the organic fiber layer provided on the active material-containing layer. The organic fiber layer includes: the first region facing the active material-containing layer; and the second region adjacent to the first region, present on the center side of the main surface of the organic fiber layer, and facing the active material-containing layer. The density D1 of the first region of the organic fiber layer is higher than the density D2 of the second region of the organic fiber layer.

### CROSS-REFERENCE TO RELATED APPLICATIONS

This application is based upon and claims the benefit of priority from Japanese Patent Application No. 2021-150365, filed Sep. 15, 2021, the entire contents of which are incorporated herein by reference.

### FIELD

Embodiments described herein relate generally to an electrode structure, a secondary battery, a battery pack, and a vehicle.

### BACKGROUND

In a secondary battery such as a lithium ion secondary battery, a porous separator is used so as to avoid a contact between a positive electrode and a negative electrode. Usually, a separator is prepared as a self-supporting film separately from an electrode body (the positive electrode and the negative electrode). The separator is disposed between the positive electrode and the negative electrode to form an electrode group, and this is wound or stacked to constitute a battery.

Examples of a general separator include a porous film made of a polyolefin resin film. Such a separator is produced, for example, by extruding a melt containing a polyolefin-based resin composition into a sheet, extracting and removing a substance other than the polyolefin-based resin, and stretching the sheet.

However, the separator made of the resin film needs to have relatively high mechanical strength so as not to be broken during production of a battery, and therefore, it is difficult to thin the separator beyond a certain extent. Hence, when the separator made of the resin film is used, it is difficult to improve the volumetric energy density of the battery. Further, when the thickness and density of the separator are too large, rapid movement of lithium ions between electrodes may be inhibited, and the input and output performance of the battery may be deteriorated.

Hence, it has been proposed to use, as the separator, organic fiber deposits instead of the separator made of the resin film. Such organic fiber deposits do not need high mechanical strength. For this reason, the film thickness of the separator made of such organic fiber deposits can be made smaller than the film thickness of the free standing film-type separator.

However, in a case in which the organic fiber membrane is used as the separator instead of the separator made of the resin film, an internal short circuit may occur when a portion of the organic fiber membrane is peeled off from a main surface or end portion of an active material-containing layer or a current-collecting tab.

### BRIEF DESCRIPTION OF THE DRAWINGS

FIG. 1 is two views schematically showing a plan view and cross-sectional view of an electrode structure according to an example;

FIG. 2 is a schematic cross-sectional view enlargedly showing a portion X of FIG. 1;

FIG. 3 is a view in which other reference numerals are assigned to the cross-sectional view of the electrode structure, which is shown in FIG. 1;

FIG. 4 is two views schematically showing a plan view and cross-sectional view of an electrode structure according to another example;

FIG. 5 is two views schematically showing a plan view and cross-sectional view of an electrode structure according to another example;

FIG. 6 is two views schematically showing a plan view and cross-sectional view of an electrode structure according to another example;

FIG. 7 is a cross-sectional view schematically showing a state in which an electrospray device discharges a filamentous raw material solution;

FIG. 8 is a schematic view schematically showing one step of a pressing process;

FIG. 9 is a schematic view schematically showing one step of a pressing process;

FIG. 10 is a schematic view schematically showing one step of the pressing process;

FIG. 11 is a cross-sectional view schematically showing a stack on which organic fiber is stacked;

FIG. 12 is a cross-sectional view schematically showing a state in which the organic fiber is stacked on an active material-containing layer;

FIG. 13 is a cross-sectional view schematically showing an example of an electrode group;

FIG. 14 is a cross-sectional view schematically showing another example of the electrode group;

FIG. 15 is an exploded perspective view showing an example of a secondary battery according to an embodiment;

FIG. 16 is a partially developed perspective view of an electrode group provided in the secondary battery shown in FIG. 15;

FIG. 17 is a schematic cross-sectional view of the electrode group shown in FIG. 16, taken along a line XVII-XVII;

FIG. 18 is a partially cutaway perspective view showing another example of the secondary battery according to the embodiment;

FIG. 19 is a perspective view schematically showing an example of an battery module according to an embodiment;

FIG. 20 is an exploded perspective view schematically showing an example of a battery pack according to an embodiment;

FIG. 21 is a block diagram showing an example of an electrical circuit of the battery pack shown in FIG. 20;

FIG. 22 is a partially transparent view schematically showing an example of a vehicle according to an embodiment; and

FIG. 23 is a view schematically showing a control system regarding an electrical system in the vehicle according to the embodiment.

### DETAILED DESCRIPTION

According to one embodiment, an electrode structure is provided. The electrode structure includes: the current collector; the active material-containing layer provided on at least one surface of the current collector; and the organic fiber layer provided on the active material-containing layer. The organic fiber layer includes: the first region facing the active material-containing layer; and the second region adjacent to the first region, present on the center side of the main surface of the organic fiber layer, and facing the active material-containing layer. The outer edge of the first region included in the organic fiber layer overlaps the outline of the main surface of the active material-containing layer along the stack direction of the active material-containing layer and the organic fiber layer. The density D1 of the first region of the organic fiber layer is higher than the density D2 of the second region of the organic fiber layer.

According to another embodiment, a secondary battery is provided. The secondary battery includes the electrode structure according to the embodiment, a counter electrode that faces the electrode structure, and an electrolyte.

According to another embodiment, a battery pack is provided. The battery pack includes the secondary battery according to the embodiment.

According to another embodiment, a vehicle is provided. The vehicle includes the battery pack according to the embodiment.

Embodiments will be described below with appropriate reference to the drawings. Note that the same reference numerals are given to constituents common throughout the embodiments, and a duplicate description will be omitted. Moreover, the respective drawings are schematic views for describing the embodiments and promoting the understanding thereof. Shapes, dimensions, and ratios in the drawings are sometimes different from those of actual devices; however, designs thereof can be appropriately changed in consideration of the following description and the known technology.

In the specification and the claims in the present application, a stack in which organic fiber membrane is integrally provided on an active material-containing layer provided in an electrode will be referred to as an “electrode structure”. When the electrode structure is stamped by a mold or the like, there is a problem that the organic fiber membrane stacked on an end portion (edge portion) of the active material-containing layer is apt to be peeled off. The peel off of the organic fiber membrane in such an electrode edge portion, a burr of the active material-containing layer, or the like makes it easy to generate an internal short circuit. Therefore, a self-discharge amount tends to increase.

Accordingly, in order to suppress the peel off of the organic fiber membrane in the electrode edge portion, in some cases, before or after stamping using a mold or the like, the entire surface of the organic fiber membrane is pressurized by a roll press or the like, and the organic fiber membrane is strongly adhered to the active material-containing layer. In this case, the peel off of the organic fiber membrane from the active material-containing layer can be suppressed. However, a density of the organic fiber membrane increases excessively, and therefore, there is a problem that battery resistance increases since ion conduction between positive and negative electrodes is inhibited. As described above, the battery resistance and the self-discharge amount are generally in a trade-off relationship.

In accordance with the electrode structure according to each of the embodiments, which will be described below, it is possible to achieve a secondary battery with low resistance and suppressed self-discharge.

### First Embodiment

According to a first embodiment, an electrode structure is provided. The electrode structure includes: the current collector; the active material-containing layer provided on at least one surface of the current collector; and the organic fiber layer provided on the active material-containing layer. The organic fiber layer includes: the first region facing the active material-containing layer; and the second region adjacent to the first region, present on the center side of the main surface of the organic fiber layer, and facing the active material-containing layer. The outer edge of the first region included in the organic fiber layer overlaps the outline of the main surface of the active material-containing layer along the stack direction of the active material-containing layer and the organic fiber layer. The density D1 of the first region of the organic fiber layer is higher than the density D2 of the second region of the organic fiber layer.

Hereinafter, the electrode structure according to the embodiment will be described with reference to the drawings.

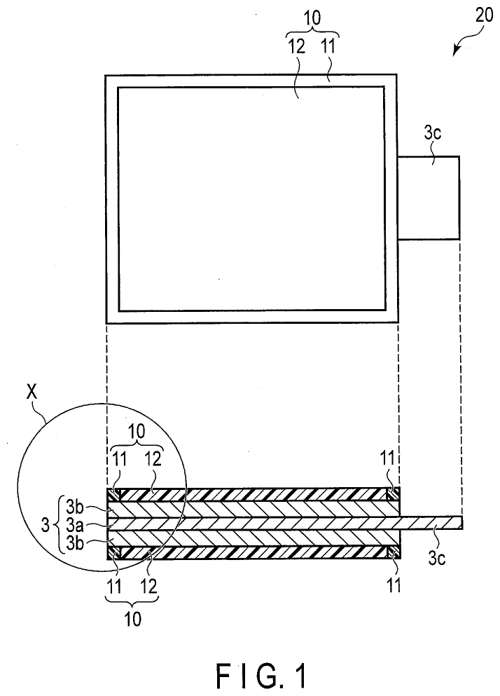

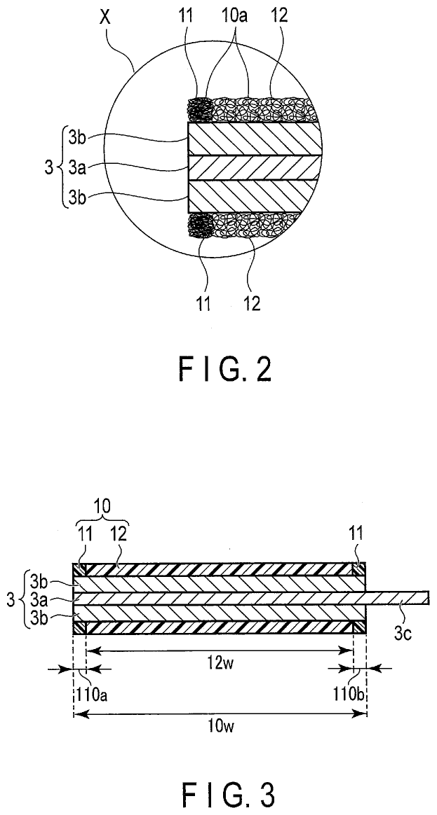

FIG. 1 is two views schematically showing a plan view and cross-sectional view of an electrode structure according to an example. FIG. 2 is a cross-sectional view enlargedly showing a portion X of FIG. 1.

An electrode structure 20 includes: a current collector 3a; an active material-containing layer 3b provided on at least one surface of the current collector 3a; and an organic fiber layer 10 provided on the active material-containing layer 3b. The current collector 3a and the active material-containing layer 3b can constitute an electrode 3.

The current collector 3a has, for example, a sheet shape as illustrated. The current collector 3a may have a porous or mesh form. As shown in FIG. 1, the current collector 3a has a shape in which, for example, a part on a side among four sides of rectangular foil protrudes in parallel to a short-side direction. Such a protruding portion can function as a current-collecting tab 3c. The shape of the current collector 3a is not limited to this, and may be other shapes such as a belt shape, a circular shape, and an elliptical shape.

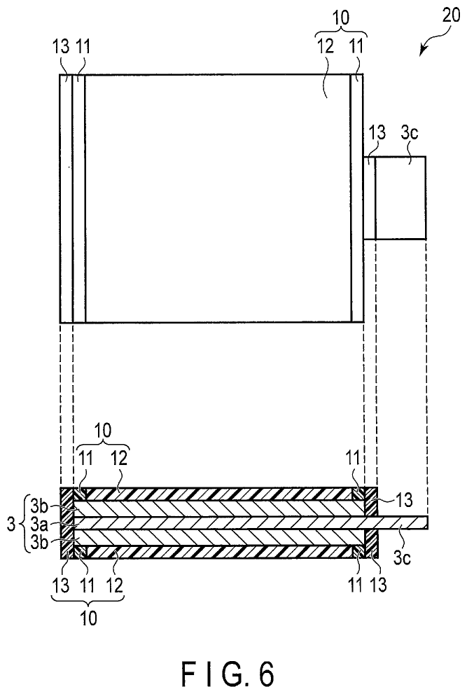

On at least one surface of the current collector 3a, the active material-containing layer 3b and the organic fiber layers 10 are stacked in this order. FIG. 1 shows a case where the active material-containing layers 3b and the organic fiber layers 10 are stacked on both surfaces of the current collector 3a. The active material-containing layer 3b and the organic fiber layer 10 may be stacked on only one surface of the current collector 3a. Neither the active material-containing layer 3b nor the organic fiber layer 10 is provided on the current-collecting tab 3c provided in the current collector 3a. Therefore, main surfaces of the current collector 3a are exposed, for example, in the current-collecting tab 3c. As will be described later with reference to FIG. 6, the organic fiber layers 10 may be partially stacked on the current-collecting tab 3c.

The main surface of the current collector 3a is partially coated with each of the active material-containing layers 3b. FIG. 1 shows, as an example, the case where the entire surface of the main surface, which excludes the current-collecting tab 3c of the current collector 3a is coated with each of the active material-containing layers 3b. The active material-containing layer 3b is, for example, a layer having a sheet shape that extends in parallel to the main surface of the current collector 3a.

The electrode 3 can function as a negative electrode or a positive electrode. That is, the electrode structure 20 according to the embodiment can be a negative electrode structure or a positive electrode structure. Hereinafter, the negative electrode and the positive electrode will be described in detail.

(Negative Electrode)

(Negative Electrode Current Collector and Tab)

Examples of the negative electrode current collector include a foil made of a conductive material. Examples of the conductive material include aluminum or an aluminum alloy.

The negative electrode tab is preferably made of the same material as the negative electrode current collector. The negative electrode tab may be provided by preparing a metal foil separately from the negative electrode current collector and connecting the metal foil to the negative electrode current collector by welding or the like.

(Negative Electrode Active Material-Containing Layer)

The negative electrode active material-containing layer may be formed on both sides of the negative electrode current collector, but can also be formed on only one side of the negative electrode current collector. The negative electrode active material-containing layer contains particles of the negative electrode active material. Therefore, the main surface of the active material-containing layer may have minute unevenness.

As a negative electrode active material, carbon materials including graphite, tin/silicon-based alloy materials and the like can be used, but preferably used is a titanium-containing oxide. As the titanium-containing oxide, a lithium titanium composite oxide, a niobium titanium composite oxide, a sodium niobium titanium composite oxide, and the like can be used.

The lithium titanium oxide includes, for example, a lithium titanium oxide with a spinel structure (for example, a general formula Li₄₊ₓTi₅O₁₂ (x is −1≤x≤3)), a lithium titanium oxide with a ramsdellite structure (for example, Li₂₊ₓTi₃O₇ (−1≤x≤3)), Li₁₊ₓTi₂O₄ (0≤x≤1), Li_{1.1+x}Ti_{1.8}O₄ (0≤x≤1), Li_{1.07+x}Ti_{1.86}O₄ (0≤x≤1), LiₓTiO₂ (0<x≤1), and the like. Further, the lithium titanium oxide may be a lithium titanium composite oxide into which a different element is introduced.

The niobium titanium composite oxide includes, for example, those represented by LiₐTiM_{b}Nb_{2+β}O_{7±σ} (0≤a≤5, 0≤b≤0.3, 0≤β≤0.3, 0≤σ≤0.3, M is at least one element selected from the group consisting of Fe, V, Mo, and Ta).

The sodium titanium composite oxide includes, for example, an orthorhombic-type Na-containing niobium titanium composite oxide represented by a general formula Li₂₊ᵥNa_{2-w}M1ₓTi_{6-y-z}M2_{z}O_{14+δ} (0≤v≤4, 0≤w<2, 0≤x<2, 0≤y<6, 0≤z<3, −0.5≤δ≤0.5, M1 includes at least one selected from Cs, K, Sr, Ba, and Ca, and M2 includes at least one selected from Zr, Sn, V, Ta, Mo, W, Fe, Co, Mn, and Al).

The average particle size of the primary particles of the negative electrode active material is preferably in the range of 0.001 μm to 1 μm. The average particle size can be obtained by, for example, observing the negative electrode active material with a scanning electron microscope (SEM). The particle shape may be granular or fibrous. In the case of the fibrous shape, the fiber diameter is preferably 0.1 μm or less. Specifically, the average particle size of the primary particles of the negative electrode active material can be measured from an image observed with an SEM. When lithium titanate having an average particle size of 1 μm or less is used as the negative electrode active material, a negative electrode active material-containing layer having high surface flatness can be obtained. In addition, when lithium titanate is used, a negative electrode potential is nobler than that of a lithium ion secondary battery using a common carbon negative electrode. Therefore, precipitation of lithium metal does not occur in principle. The negative electrode active material containing lithium titanate can be prevented from collapsing the crystal structure of the active material because the expansion and contraction associated with the charge-and-discharge reaction is small.

The negative electrode active material-containing layer may contain at least one of a conductive agent and a binder in addition to the negative electrode active material.

Examples of the electro-conductive agent can include carbon black such as acetylene black, black lead, carbon nanofiber, carbon nanotube, or mixtures of these.

Examples of the binder can include polytetrafluoroethylene (PTFE), polyvinylidenefluoride (PVdF), fluorine-based rubber, styrene butadiene rubber, a polyacrylic acid compound, an imide compound, carboxylmethylcellulose (CMC), salt of CMC, or mixtures of these.

(Positive Electrode)

(Positive Electrode Current Collector and Tab)

Examples of the positive electrode current collector include a foil made of a conductive material. Examples of the conductive material include aluminum and an aluminum alloy.

The positive electrode tab is preferably made of the same material as the positive electrode current collector. The positive electrode tab may be provided by preparing a tab separately from the positive electrode current collector and connecting the tab to the positive electrode current collector by welding or the like.

(Positive Electrode Active Material-Containing Layer)

The positive electrode active material-containing layer may be formed on both sides of the positive electrode current collector, but can also be formed on only one side of the positive electrode current collector.

A positive electrode active material-containing layer contains particles of the positive electrode active material. Therefore, a main surface of the positive electrode active material-containing layer can have minute irregularities.

As the positive electrode active material, for example, a lithium transition metal composite oxide can be used. Examples of the lithium transition metal composite oxide include LiCoO₂, LiNi₁₋ₓCoₓO₂ (0<x<0.3), LiMnₓNi_{y}CO_{z}O₂ (0<x<0.5, 0<y<0.5, 0≤z<0.5), LiMn₂₋ₓMₓO₄ (M is at least one element selected from the group consisting of Mg, Co, Al, and Ni, 0<x<0.2), LiMPO₄ (M is at least one element selected from the group consisting of Fe, Co, and Ni), and the like.

The positive electrode active material-containing layer may contain at least one of a conductive agent and a binder in addition to the positive electrode active material. As the binder and the conductive agent, the same materials as described in the negative electrode active material-containing layer can be used.

(Organic Fiber Layer)

Each of the organic fiber layers 10 includes: a first region 11 facing the active material-containing layer 3b; and a second region 12 adjacent to the first region 11, present on a center side of the main surface of the organic fiber layer 10, and facing the active material-containing layer 3b. The entire surface of the active material-containing layer 3b is coated with the first region 11 and the second region 12, which are included in the organic fiber layer 10. An outer edge of the first region 11 overlaps an outline of a main surface of the active material-containing layer 3b along a stack direction of the active material-containing layer 3b and the organic fiber layer 10. That is, the entire surface of the first region 11 and the entire surface of the second region 12 face the active material-containing layer 3b.

In the example shown in FIG. 1, the outline of the main surface of the active material-containing layer 3b and an outer edge shape of the first region 11 are both rectangular. Sizes of such rectangles are substantially the same. In FIG. 1, the first region 11 is provided in a frame shape (on four sides of a rectangle) so that a peripheral edge portion of the active material-containing layer 3b, which is a portion on the main surface of the active material-containing layer 3b is coated with the first region. The first region 11 just needs to be provided so that at least a part of the peripheral edge portion of the active material-containing layer 3b is coated with the first region. For example, the first region 11 may be provided on only one side among four sides of the main surface of the active material-containing layer 3b, which constitute the outline of the active material-containing layer 3b.

The organic fiber layer 10 can function as a separator that prevents contact between the positive and negative electrodes. As shown in FIG. 2, the organic fiber layer 10 includes plural pieces of organic fiber 10a. The organic fiber layer 10 can have a three-dimensional network structure in which the plural pieces of organic fiber 10a intersect one another in a network shape. Note that the organic fiber included in the first region 11 is sometimes referred to as “first organic fiber”. The organic fiber included in the second region 12 is sometimes referred to as “second organic fiber”.

A ratio of an area of a portion, which is not coated with the organic fiber layer 10, with respect to an area of the main surface of the active material-containing layer 3b, that is, an electrode exposure area ratio is preferably 5% or less, more preferably 0%. In accordance with an example, the electrode exposure area ratio of the organic fiber layer 10 in the first region 11 is smaller than the electrode exposure area ratio thereof in the second region 12.

Note that the electrode exposure area ratio can be measured by, for example, a digital microscope. Specifically, first, the electrode is observed at a magnification of 250 times by using a digital scope. Next, image processing is performed on an observation image of 14 mm² by a color extraction method. Therefore, the ratio of the portion that is not covered with the organic fibers in the main surface of the active material-containing layer can be calculated.

The organic fiber layer 10 has pores and the average pore diameter of the pores is preferably 5 nm to 10 μm. In addition, the porosity is preferably 10% to 90%. If such pores are provided, a separator having excellent ion permeability and excellent electrolyte impregnating property can be obtained. The porosity is preferably 40% or more, and more preferably 70% or more. The average pore diameter and the porosity of the pores can be confirmed by a mercury intrusion technique, calculation from volume and density, SEM observation, scanning ion microscope (SIM) observation, or gas desorption method. The porosity is preferably calculated from the volume and the density of the organic fiber layer 10. In addition, it is preferable to measure the average pore size by a mercury intrusion technique or a gas desorption technique. The high porosity of the organic fiber layer 10 means that the influence of interfering ion migration is small.

In the organic fiber layer 10, if the contained organic fibers 10a are in a sparse state, the porosity is increased, and thus it is not difficult to obtain a layer having, for example, a porosity of about 90%. It is extremely difficult to form such a layer having a large porosity with particles.

The organic fiber layer 10 is advantageous over inorganic fiber deposits in terms of unevenness, susceptibility to cracking, electrolytic solution resistance, adhesion, bending properties, porosity, and ion permeability.

As shown in FIG. 2, the density D1 of the first region 11 of the organic fiber layer 10 is higher than the density D2 of the second region 12 of the organic fiber layer 10. Hence, a contact area per unit area between the plural pieces of organic fiber included in the first region 11 and the active material-containing layer 3b is larger than a contact area per unit area between the plural pieces of organic fiber included in the second region 12 and the active material-containing layer 3b. Therefore, in the first region 11, the organic fiber layer 10 is excellent in adhesion to the active material-containing layer 3b. That is, the organic fiber layer 10 is difficult to peel off. In accordance with an example, peel strength of the first region 11 is larger than peel strength of the second region 12.

Meanwhile, the density D2 of the second region 12 is low, and therefore, ion conduction between the active material-containing layer 3b and a counter electrode through the second region 12 is less likely to be inhibited. As a result of these, in accordance with the electrode structure according to the embodiment, it is possible to achieve the secondary battery with low resistance and suppressed self-discharge.

(Peel Strength)

The adhesion between the organic fiber layer 10 and the active material-containing layer 3b can be evaluated, for example, by the 180 degree peel adhesion testing method prescribed in the Japanese Industrial Standard JIS Z 0237: 2009 “Testing methods of pressure-sensitive adhesive tapes and sheets”. By this test, the adhesion between the first region 11 and the active material-containing layer 3b and the adhesion between the second region 12 and the active material-containing layer 3b can be compared with each other.

Specifically, first, a battery is disassembled, and the electrode structure is taken out therefrom. Subsequently, this electrode structure is cleaned by using an organic solvent such as ethylene carbonate (EC), dimethyl carbonate (DMC), ethylmethyl carbonate (EMC), and diethyl carbonate (DEC), and is vacuum dried, and an electrode structure as a measurement sample is obtained. The electrode structure thus taken out is cut out so as to have the same width as a width of an adhesive tape, and the measurement sample is obtained. At this time, in the case of measuring the peel strength of the first region 11, the electrode structure is cut out so that the width of the first region 11 and the width of the adhesive tape are the same. Further, in the case of measuring the peel strength of the second region 12, the electrode structure is cut out so that the width of the second region 12 and the width of the adhesive tape are the same.

Subsequently, a part of the measurement sample is cut, and a specimen is obtained. As the specimen, one portion of both end portions in a long-side direction of the active material-containing layer 3b may be used, or a portion on a central portion of the active material-containing layer 3b may be used. Subsequently, the adhesive tape is pressure-bonded onto the organic fiber layer 10 of the specimen, and is set to a tensile testing machine. Subsequently, the adhesive tape is pulled, whereby the organic fiber layer 10 is peeled off from the active material-containing layer 3b. A length in a short-side direction of the adhesive tape is set, for example, to 12 mm, and a length in a long-side direction thereof is set, for example, to 75 mm or more. A test speed is set to 5 mm/s, and an average value of adhesive forces, each of which is obtained by peeling off the adhesive tape by 25 mm is defined as peel strength.

The peel strength obtained by this test can be defined as an index of the adhesion between the organic fiber layer 10 and the active material-containing layer 3b.

In accordance with an example, the peel strength of the first region 11 is 10 mN/10 mm or more and 300 mN/10 mm or less. In accordance with another example, the peel strength of the first region 11 is 20 mN/10 mm or more and 300 mN/10 mm or less. In accordance with still another example, the peel strength of the first region 11 is 30 mN/10 mm or more and 300 mN/10 mm or less. In accordance with an example, the peel strength of the second region 12 is 5 mN/10 mm or more and less than 10 mN/10 mm. In accordance with another example, the peel strength of the second region 12 is 5 mN/10 mm or more and less than 20 mN/10 mm or less. In accordance with still another example, the peel strength of the second region 12 is 5 mN/10 mm or more and less than 30 mN/10 mm or less. As mentioned above, the peel strength of the first region 11 may be larger than the peel strength of the second region 12.

(Density)

The density D1 of the first region is, for example, in a range of 0.10 g/cm³ to 1.0 g/cm³, preferably in a range of 0.40 g/cm³ to 0.80 g/cm³. The density D1 of the first region may be larger than 0.60 g/cm³. The density D1 of the first region may be in a range of larger than 0.60 g/cm³ and 0.80 g/cm³ or less. A value of the density D1 of the first region is not particularly limited if the density D1 is larger than the density D2 of the second region. However, it is not preferable that the density D1 of the first region is too low since the peel strength of this first region from the active material-containing layer 3b also tends to be low. Further, it is not preferable that the density D1 of the first region is too high since the conduction of ions between the positive and negative electrodes through the first region may be inhibited.

The density D2 of the second region is, for example, in a range of 0.10 g/cm³ to 1.0 g/cm³, preferably in a range of 0.30 g/cm³ to 0.60 g/cm³. It is not preferable that the density D2 of the second region is too low since irregularities present on the surface of the counter electrode may penetrate the second region to cause an internal short circuit. It is not preferable that the density D2 of the second region is too high since the conduction of ions between the positive and negative electrodes through the second region may be inhibited.

A ratio D1/D2 of the density D1 of the first region with respect to the density D2 of the second region is larger than 1.0. The ratio D1/D2 is, for example, in a range of larger than 1.0 and 3.0 or less, preferably in a range of 1.5 or more and 2.0 or less. The ratio D1/D2 may be in a range of 1.1 or more and 3.0 or less. When the ratio D1/D2 is less than 1.0, an effect of suppressing the peel off of the peripheral edge portion of the organic fiber layer, that is, the first region cannot be obtained, and further, the conduction of ions between the positive and negative electrodes in the second region may be inhibited. When the ratio D1/D2 is too high, the conduction of ions between the positive and negative electrodes through the first region may be inhibited to increase internal resistance.

(Thickness)

Both of a thickness of the first region 11 of the organic fiber layer 10 and a thickness of the second region 12 thereof are, for example, in a range of 1 μm to 20 μm, preferably in a range of 2 μm to 10 μm. Herein, the thickness (thickness of each region) of the organic fiber layer 10 refers to a thickness in a stack direction of the active material-containing layer 3b and the organic fiber layer 10, that is, refers to a film thickness. The thickness of the first region 11 and the thickness of the second region 12 may be the same, or may be different from each other.

When the thickness of the organic fiber layer 10 is too small, the self-discharge amount tends to increase since a distance between the positive and negative electrodes is reduced. When the thickness of the organic fiber layer 10 is too large, the battery resistance may increase. Further, when the thickness of the first region 11 corresponding to the peripheral edge portion is too large, the contact between the counter electrode and the second region 12 of the organic fiber layer 10 may be lost, and an unnecessary gap portion may be formed between the organic fiber layer 10 and the counter electrode. This case is not preferable since a battery capacity decreases.

The thickness of the first region 11 may be smaller or larger than the thickness of the second region 12. For example, the thickness of the first region 11 is the same as or smaller than the thickness of the second region 12. A ratio T1/T2 of the thickness T1 of the first region with respect to the thickness T2 of the second region is, for example, in a range of 0.3 to 1.1. In accordance with another example, the ratio T1/T2 is in a range of 0.5 to 0.8. When the ratio T1/T2 is too large, resistance between the positive and negative electrodes tends to increase since the distance therebetween is increased, and an energy density per unit volume as the electrode structure tends to decrease since the thickness of the organic fiber layer is larger than the thickness of the active material-containing layer.

(Mass Per Unit Area)

A mass per unit area of the first region 11 is preferably 0.1 g/m² or more and 20 g/m² or less, more preferably 0.5 g/m² or more and 5 g/m² or less. A mass per unit area of the second region 12 is preferably 0.1 g/m² or more and 20 g/m² or less, more preferably 0.5 g/m² or more and 5 g/m² or less. The mass per unit area of the first region 11 and the mass per unit area of the second region 12 may be the same, or may be different from each other.

A ratio M1/M2 of the mass per unit area M1 of the first region with respect to the mass per unit area M2 of the second region is, for example, in a range of 0.5 or more and 3.0 or less, preferably in a range of larger than 1.0 and 2.0 or less. When the ratio M1/M2 is increased to more than 1.0, there is an advantage that it is easier to increase the density D1 of the first region 11 than the density D2 of the second region. This will be described in a manufacturing method of the electrode structure, which will be described later.

(Organic Fiber)

The organic fibers 10a include, for example, at least one organic material selected from the group consisting of polyamideimide (PAI), polyether imide (PEI), polyimide (PI), polyamide (PA), polyvinylidene fluoride (PVdF), polyethylene, polypropylene, polytetrafluoroethylene (PTFE), polyphenylene sulfide (PPS), liquid crystalline polyester (LCP), polyether sulfone (PES), polyether ketone (PEK), polyether ether ketone (PEEK), polyethylene terephthalate (PET), cellulose, polyolefin, polyketone, polysulfone, cellulose, and polyvinyl alcohol (PVA).

Examples of the polyolefin include polypropylene (PP) and polyethylene (PE). It is generally considered that PVdF and PI are difficult materials to be in the form of fibers. When an electrospinning method described later is employed, such materials can also form a layer as the form of fibers. The kind of the organic material of the organic fibers 10a can be one kind or two or more kinds.

Preferable examples include at least one kind selected from the group consisting of polyamide, polyimide, polyamideimide, cellulose, PVdF, and PVA, and more preferable examples include at least one selected from the group consisting of polyamide, polyimide, polyamideimide, and PVdF.

In particular, the organic fibers 10a containing at least one of polyamideimide and polyimide are insoluble or infusible at 250° C. to 400° C. and does not decompose. The organic fiber layer 10 having excellent heat resistance can be obtained.

The length of the organic fiber 10a is preferably 1 mm or more. In addition, the average diameter of the cross sections perpendicular to the length direction of the organic fibers 10a is preferably 2 μm or less, and more preferably 1 μm or less. An example of a lower limit value of the average diameter of the organic fibers 10a is 0.05 μm. The organic fiber layer 10 including the organic fibers 10a having a sufficient length and a small average diameter has sufficient strength, porosity, air permeability, pore size, electrolytic solution resistance, redox resistance, and the like, the organic fiber layer 10 functions well as the separator. The length and the average diameter of the organic fibers 10a can be measured by SEM observation.

An average diameter of the first organic fiber and an average diameter of the second organic fiber may be the same, or may be different from each other. The average diameter of the first organic fiber and the average diameter of the second organic fiber are preferably the same or substantially the same. Bothe of the average diameters of the first organic fiber and the second organic fiber can be in a range of 0.05 μm to 2 μm.

A composition of the organic fiber 10a (first organic fiber) that constitutes the first region 11 and a composition of the organic fiber 10a (second organic fiber) that constitutes the second region may be the same, or may be different from each other.

As mentioned above, in the example shown in FIG. 1, the first region 11 is provided in a frame shape (on four sides) so that the peripheral edge portion on the main surface of the active material-containing layer 3b is coated with the first region. In other words, the first region 11 included in the organic fiber layer 10 is provided so as to face the active material-containing layer 3b at positions individually corresponding to four sides of the active material-containing layer 3b, which are provided in a rectangular shape. The second region 12 included in the organic fiber layer 10 is provided so as to face the active material-containing layer 3b at a position that is adjacent to the first region 11 provided in a frame shape and is on the center side of the main surface of the organic fiber layer 10. The entire surface of the first region 11 of the organic fiber layer 10 and the entire surface of the second region 12 of the organic fiber layer 10 can face the active material-containing layer 3b.

The outer edge shape of the first region 11 overlaps the outline of the active material-containing layer 3b, and therefore, can be rectangle like the outline of the active material-containing layer 3b. Meanwhile, an inner peripheral shape of the first region 11 or an outer peripheral shape of the second region 12 are rectangles similar to the above-described rectangle and are rectangles each having an area smaller than the above-described rectangle. That is, the outer edge shape and inner peripheral shape of the first region 11 are rectangles similar to each other. However, these do not need to be similar rectangles. For example, when the electrode structure 20 is observed in a direction perpendicular to the main surface of the organic fiber layer 10, the outer edge shape of the first region 11 may be rectangular, and the inner peripheral shape of the first region 11 may be circular.

In general, the peel off of the organic fiber layer 10 is likely to occur at the position of the end portion (edge portion) of the electrode structure 20. However, when the first region 11 is present on four sides as shown in FIG. 1, the peel off of the organic fiber layer 10 from the end portion can be suppressed on all of the sides. Therefore, in this case, the self-discharge amount can be suppressed to be low since it is easy to suppress the internal short circuit.

(Width)

A width of the organic fiber layer 10 will be described with reference to FIG. 3.

FIG. 3 shows a cross-sectional view in a case of cutting the electrode structure 20 shown in FIG. 1 in parallel to the long-side direction thereof. The organic fiber layer 10 has a width 10w that is along the long-side direction. The first region 11 has a width 110a and a width 110b which are along the long-side direction. A width of the first region 11 is a total value of these widths 110a and 110b. Further, the second region 12 has a width 12w that is along the long-side direction. FIG. 3 shows the widths of the respective portions for the case where the electrode structure 20 is cut in parallel to the long-side direction. However, the description of the widths of the respective portions is also applied to the case where the electrode structure 20 is cut in parallel to the short-side direction.

A ratio of the width of the first region 11 with respect to the width (width excluding that of the current-collecting tab 3c) that is along the long-side direction of the organic fiber layer 10 and the width that is along the short-side direction thereof is, for example, in a range of 1% to 40%. That is, the first region 11 can be formed from a position (electrode edge portion) with this ratio of 0% to positions of 1% to 40% thereof along the long-side direction or short-side direction of the electrode structure 20. For the width 110a on one end portion that is along the long-side direction or the short-side direction, the above-described ratio can be, for example, in 1% to 20%. Further, for the width 110b on the other end portion that is along the long-side direction or the short-side direction, the above-described ratio can be, for example, in 1% to 20%. The ratio of the width of the first region 11 with respect to the width (width excluding that of the current-collecting tab 3c) that is along the long-side direction of the organic fiber layer 10 and the width that is along the short-side direction thereof may be, for example, in a range of 10% to 30%.

When the above-described ratio, that is, the ratio of the width of the first region 11 with respect to the width (width excluding that of the current-collecting tab 3c) that is along the long-side direction of the organic fiber layer 10 or the width that is along the short-side direction thereof is too low, it may be difficult to obtain an effect of suppressing the peel off of the organic fiber layer 10 in the electrode edge portion. Further, it is not preferable that the above-described ratio is too high since the ion conduction through the organic fiber layer 10 is likely to be inhibited by the first region 11.

A ratio of the width of the second region 12 with respect to the width (width excluding that of the current-collecting tab 3c) that is along the long-side direction of the organic fiber layer 10 and the width that is along the short-side direction thereof is, for example, in a range of 60% to 99%. When this ratio is small, an occupation area of the first region 11 in the organic fiber layer 10 is large. Accordingly, the peel off of the organic fiber layer 10, and in particular, the peel off of the organic fiber layer 10 (first region 11) on the electrode edge portion tends to be able to be suppressed. Meanwhile, when this ratio is large, the self-discharge amount may increase though the battery resistance can be reduced.

Note that, herein, the positions, ratios, and the like of the widths of the respective portions are described for the case where the electrode structure 20 is rectangular; however, the description of these is also applied similarly to a cut surface of such an electrode structure 20 having another shape.

<Measurement Method of Thickness of Each Layer, and Width, Mass Per Unit Area, and Density of Each Portion Regarding Electrode Structure>

First, a secondary battery as an analysis target is brought into a discharged state. For example, in an environment at 25° C., the secondary battery is discharged by a current of 0.1 C to a rated termination voltage, whereby the secondary battery can be brought into a discharged state. The secondary battery brought into a discharged state is disassembled in a glove box filled with argon. An electrode structure as a measurement target is taken out from the disassembled battery. This electrode structure is cleaned by an appropriate solvent. As the solvent for use in the cleaning, for example, ethylmethyl carbonate can be used.

When the electrode structure 20 (excluding the current-collecting tab 3c) has a square or rectangular sheet shape, two sets, each of which has two sides facing each other, are included in four sides provided in this square or rectangle. The width of the electrode structure 20 is measured as follows along a straight line perpendicular to two sides facing each other, the two sides belonging to either one of the two sets. This straight line assumes to be a straight line that goes along an in-plane direction of the main surface of the current collector 3a, and passes through the first region 11 and the second region 12.

The electrode structure thus already cleaned is cut by an ion milling apparatus. At this time, the electrode structure 20 is cut along the above-described straight line, and obtains a cut surface. Note that this cutting is performed along the stack direction of the current collector, the active material-containing layer, and the organic fiber layer. On this cut surface, the width of the organic fiber layer 10, the width of the first region 11, and the width of the second region are measured. When a plurality of the first regions are present on this cut surface, the total (total value) of the widths of those first regions is regarded as the width of the first region.

The cross section of the electrode structure thus already cut is pasted onto an SEM specimen support. At this time, the electrode structure is subjected to treatment by using a conductive tape and the like so that the cut surface of the electrode does not peel off or float from the specimen support. Note that, preferably, an inert atmosphere is maintained at the time of introducing the electrode into a specimen chamber.

The thickness and density of the first region are obtained as follows.

The cross section of the electrode structure is observed by using an SEM so that positions of 1%, 2%, 3%, 4%, and 5% from the electrode edge portion are individually included when the width of the organic fiber layer is 100%, and then five SEM images are obtained. This observation is performed by such a magnification that enables an observation for the whole from one main surface of the organic fiber layer to the other main surface thereof in the SEM image obtained at each spot. Such an observation magnification is set, for example, to 2500 times. For each of the five images, the thickness of the organic fiber layer is measured at a central position in the width direction (direction parallel to the main surface of the organic fiber layer) of the electrode structure. An average value of the thicknesses of the organic fiber layer, which are obtained for the respective images, is defined as a thickness (T1) of the first region.

Separately from the above, for the cross section of the electrode structure, the electrode structure is cut out so that a position of 5% from the electrode edge portion is included when the width of the organic fiber layer is 100%. At this time, the electrode structure is cut out so that the total of cutout areas is 10 cm² or more. Note that a total value of the cutout areas is defined as an “area 1”. A weight of the electrode structure thus cut out is measured, and an obtained value is defined as a “weight 1”. Next, the organic fiber layer provided on one surface or both surfaces of the cutout electrode structure is removed. A method of removing the organic fiber layer is not particularly limited; however, for example, the organic fiber layer can be removed by such a method of scraping off the same by soft cloth. Thereafter, a weight of the electrode from which the organic fiber layer is removed is measured, and an obtained value is defined as a “weight 2”. Then, the weight 2 is subtracted from the weight 1, whereby a weight (defined as a “weight 3”) of the organic fiber layer (first region) provided in the cutout electrode structure can be obtained.

Next, the cutout area (area 1) and the previously measured thickness (T1) of the first region are multiplied by each other, whereby a volume of the first region as a measurement target is calculated. The weight 3 obtained above is divided by this volume, whereby the density D1 of the first region can be calculated. Further, the weight 3 obtained above is divided by the area 1, whereby the mass per unit area M1 of the first region can be calculated.

Meanwhile, the thickness and density of the second region are obtained as follows.

The cross section of the electrode structure is observed by using an SEM so that a position of 50% from the electrode edge portion is included when the width of the organic fiber layer 10 is 100%. This observation is performed by such a magnification that enables an observation for the whole from one main surface of the organic fiber layer 10 to the other main surface thereof in an obtained SEM image. As in the observation of the first region, an observation magnification is set, for example, to 2500 times. In the obtained SEM image, a region from one end portion of the SEM image to the other end portion thereof is quartered along the width direction (direction parallel to the main surface of the organic fiber layer) of the electrode structure, and the thickness of the organic fiber layer is measured at central positions of the respective regions. An average value of thicknesses obtained in the respective regions is defined as a thickness (T2) of the second region.

Separately from the above, for the cross section of the electrode structure, the electrode structure is cut out so that a position of 50% from the electrode edge portion is included when the width of the organic fiber layer is 100%. At this time, the electrode structure is cut out so that the total of cutout areas is 10 cm² or more. Note that a total value of the cutout areas is defined as an “area 2”. A weight of the electrode structure thus cut out is measured, and an obtained value is defined as a “weight 4”. Next, the organic fiber layer provided on one surface or both surfaces of the cutout electrode structure is removed. Thereafter, a weight of the electrode from which the organic fiber layer is removed is measured, and an obtained value is defined as a “weight 5”. Then, the weight 5 is subtracted from the weight 4, whereby a weight (defined as a “weight 6”) of the organic fiber layer (second region) provided in the cutout electrode structure can be obtained.

Next, the cutout area (area 2) and the previously measured thickness (T2) of the second region are multiplied by each other, whereby a volume of the second region as a measurement target is calculated. The weight 6 obtained above is divided by this volume, whereby the density D2 of the second region can be calculated. Further, the weight 6 obtained above is divided by the area 2, whereby the mass per unit area M2 of the second region can be calculated.

Even if the electrode structure 20 does not have a square or rectangular sheet shape, the thickness, mass per unit area, and density of each of the first region 11 and the second region 12, which are included in the organic fiber layer, can be measured by the above-mentioned method. In that case, as mentioned above, the position where the electrode structure 20 is cut goes along the in-plane direction of the main surface of the current collector 3a, and the electrode structure 20 is cut along the straight line that passes through the first region 11 and the second region 12. However, at the time of cutting the electrode structure 20, the electrode structure 20 is cut at a position where the width of the electrode structure 20 on the cut surface is maximized.

Further, the thickness of the active material-containing layer is determined as follows. That is, for the cross section of the electrode structure, the thicknesses of the active material-containing layer at the positions of 20%, 40%, 60%, and 80% from the electrode edge portion when the width of the organic fiber layer is 100% are individually observed and measured by an SEM, and an average value of these values is defined as the thickness of the active material-containing layer.

Then, another example of the electrode structure according to the embodiment will be described with reference to the drawings.

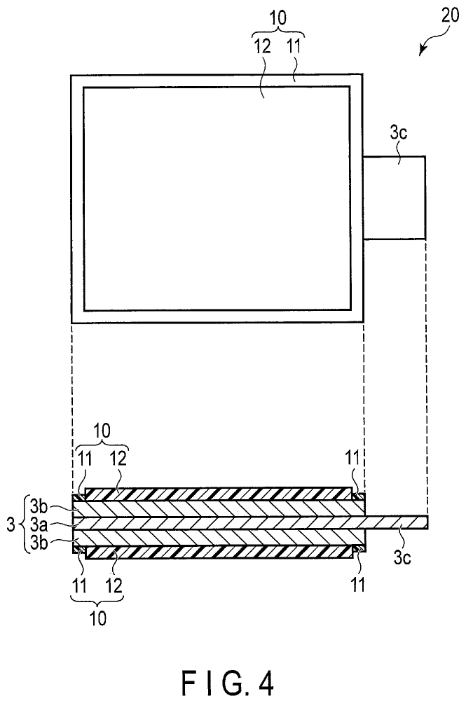

FIG. 4 is two views showing a plan view and cross-sectional view of the electrode structure according to another example. Such an electrode structure 20 shown in FIG. 4 has a similar structure to that of the electrode structure 20 shown in FIG. 1 except that the thickness of the first region 11 is smaller than the thickness of the second region 12. In the electrode structure 20 as shown in FIG. 4, the ratio T1/T2 of the thickness T1 of the first region with respect to the thickness T2 of the second region is, for example, 0.5 or more and less than 1.0.

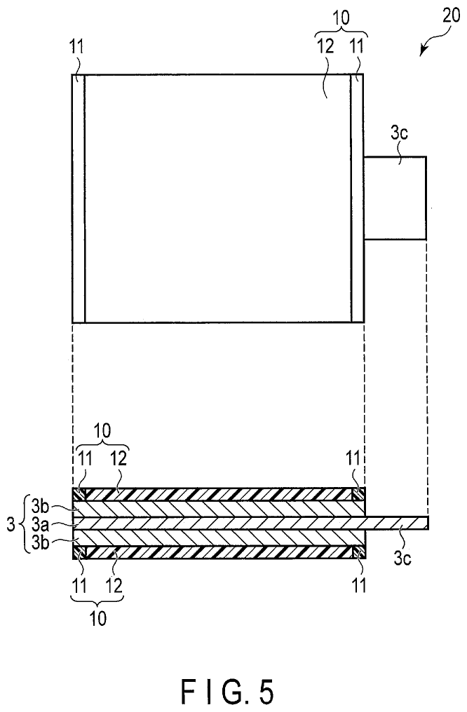

FIG. 5 is two views showing a plan view and cross-sectional view of an electrode structure according to another example. The electrode structure 20 shown in FIG. 5 has a similar structure to that of the electrode structure 20 shown in FIG. 1 except that positions where the first regions 11 are provided are different.

In the electrode structure 20 shown in FIG. 5, the first regions 11 included in the organic fiber layer 10 are provided at positions including two sides facing each other among four sides which constitute the outline corresponding to the shape of the main surface of the active material-containing layer 3b. Specifically, the first regions 11 are provided on two sides facing each other, the two sides including a side from which the current-collecting tab 3c protrudes. The first regions 11 may be provided on two sides facing each other, the two sides including a side from which the current-collecting tab 3c does not protrude. Note that, in FIG. 5, the number of first regions included in the organic fiber layer 10 is two. The number of first regions included in the organic fiber layer 10 is not particularly limited, and can be at least one.

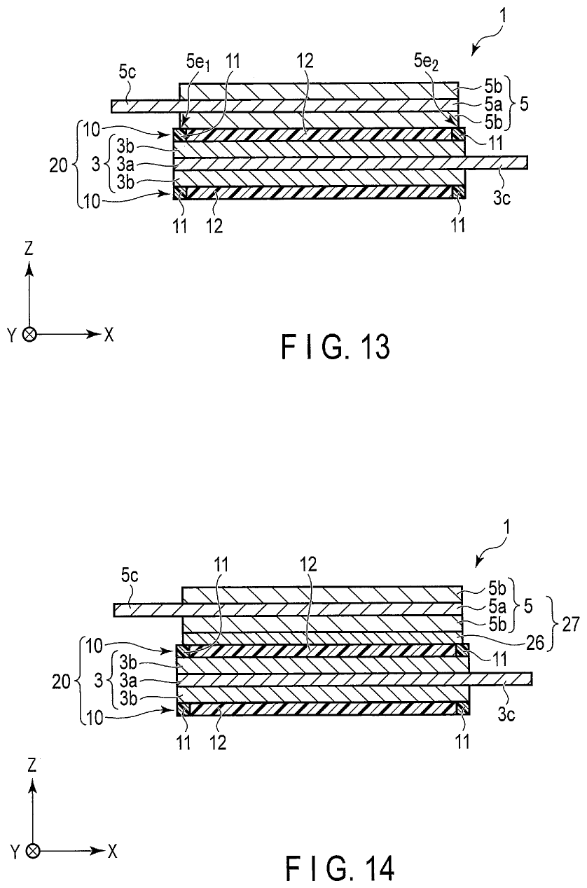

When the counter electrode is stacked on the electrode structure 20 as a positive electrode structure or a negative electrode structure, the edge portion of the counter electrode sometimes contacts the surface of the organic fiber layer 10 (for example, refer to FIG. 13 to be described later). In the vicinity of the current-collecting tab 3c, the electrode structure may be curved by external force, and in that case, the peel off, curling, or the like of the organic fiber layer 10 is likely to occur on the side from which the current-collecting tab 3c protrudes. As shown in FIG. 5, when the first regions 11 are provided on two sides among four sides which constitute the outline corresponding to the shape of the main surface of the organic fiber layer 10, the two sides facing each other in the direction where the current-collecting tab 3c protrudes, there is an effect of easily suppressing the peel off, the curling, or the like, which is as described above. This configuration is preferable since it is easier to suppress the self-discharge as a result.

FIG. 6 is two views showing a plan view and cross-sectional view of an electrode structure according to another example. Such an electrode structure 20 shown in FIG. 6 has a similar structure to that of the electrode structure 20 shown in FIG. 5 except that the organic fiber layer 10 further includes third regions 13.

In the electrode structure 20 shown in FIG. 6, the third regions 13 are organic fiber layers formed continuously with the first regions 11. Each of the third regions 13 is a part of the organic fiber layer 10, but is a region that does not face the main surface of the active material-containing layer 3b. At least a part of the side surface of the active material-containing layer 3b and at least a part of the side surface of the current collector 3a can be coated with each of the third regions 13. A part of the current-collecting tab 3c can be coated with the third regions 13. When the organic fiber layer 10 further includes the third regions 13, the adhesion between the organic fiber layer 10 and the active material-containing layer 3b and/or the current-collecting tab 3c further increases, and the internal short circuit of the secondary battery tends to be able to be suppressed.

Note that a composition, density, thickness, and the like of the organic fiber which constitutes the third regions 13 can be, for example, similar to those of the above-mentioned second region 12.

(Manufacturing Method)

Next, a description will be given of an example of the manufacturing method of the electrode structure according to the embodiment. The electrode structure according to the embodiment can be manufactured, for example, by a first manufacturing method or a second manufacturing method, which will be described below.

(First Manufacturing Method)

First, the electrode 3 illustrated in FIG. 1 is prepared. For example, slurry containing an active material, an electro-conductive agent, and a binder is prepared. Subsequently, the obtained slurry is applied to at least one main surface of the current collector 3a, followed by drying, whereby the active material-containing layer 3b is formed. Subsequently, the active material-containing layer 3b is subjected to a pressing process, and is cut to a desired dimension according to needs. Further, the slurry is not applied to a part of the current collector 3a, and this part is used as the current-collecting tab 3c. The electrode 3 shown in FIG. 1 is obtained in the way described above.

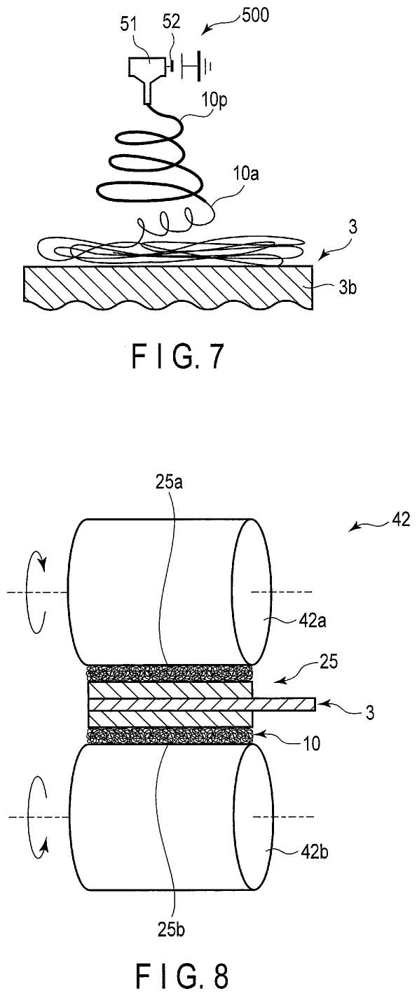

Next, for example, by an electrospinning method, the organic fiber layer 10 is formed on the active material-containing layer 3b. This method will be described in detail with reference to FIG. 7. FIG. 7 is a cross-sectional view schematically showing a state in which an electrospray device discharges a filamentous raw material solution.

When the organic fiber layer 10 is formed, first, a raw material solution is prepared. The raw material solution is prepared by dissolving an organic material in a solvent. Examples of the organic material may be the same as those described for the organic material constituting the organic fiber 10a. As the solvent, those capable of dissolving the organic material can be used. Examples of the solvent include N-methylpyrrolidone (NMP), dimethylacetamide (DMAc), dimethyl sulfoxide (DMSO), N,N-dimethylformamide (DMF), water, and alcohols. The concentration of the organic material in the raw material solution is preferably 5 mass to 60 mass %.

Then, the electrospray device 500 shown in FIG. 7 is prepared. The electrospray device 500 includes a spinning nozzle 51, a high voltage generator 52 applying a voltage to the spinning nozzle 51, a metering pump supplying the raw material solution to the spinning nozzle 51, and a tank storing the raw material solution. The metering pump and the tank are not shown. In addition, as the electrode facing the spinning nozzle 51, the electrode 3 obtained by the above-described method can be used. The spinning nozzle 51 may be a single nozzle or a multi-nozzle.

Next, as shown in FIG. 7, a thread-shaped raw material solution 10p is discharged from the spinning nozzle 51 toward the surface of the electrode 3 while applying the voltage to the spinning nozzle 51 using the high voltage generator 52 by the electrospinning method. The discharged raw material solution 10p approaches the electrode 3 while drawing a spiral shape. At this time, the raw material solution 10p charged by the voltage applied to the spinning nozzle 51 is drawn from the spinning nozzle 51 toward the electrode 3. Therefore, since the surface area of the raw material solution 10p rapidly increases, the solvent is volatilized from the raw material solution 10p, and the charge amount per unit volume of the raw material solution 10p is increased. Therefore, when the raw material solution 10p discharged from the spinning nozzle 51 reaches the electrode 3, the raw material solution 10p is deposited on the electrode 3 as the nano-sized organic fiber 10a in a state in which the solvent is almost completely volatilized.

Hence, at the time of reaching the electrode 3, such a raw material solution 10p discharged from a spinning nozzle 51 is deposited as the nano-sized organic fiber 10a on the electrode 3 in a state in which the solvent is volatilized almost completely (a first deposition step).

Here, since the charged organic fiber 10a is attracted to the oppositely charged electrode 3 by electrostatic force, the charged organic fiber 10a is deposited on the electrode 3 over a region wider than a discharge port of the spinning nozzle 51. In particular, since the current collector and the tab are more easily charged than the active material-containing layer, the organic fiber 10a is likely to be drawn onto the current collector and the tab. As a result, as described with reference to FIG. 6 for example, the organic fiber layer 10 is sometimes formed, which includes the third regions 13 with which the side surface of the active material-containing layer 3b, the side surface of the current collector 3a, and the current-collecting tab 3c are partially coated. The third regions 13 thus formed may be removed according to needs, for example, at the point of time such as before the pressing process to be described later or after the pressing process.

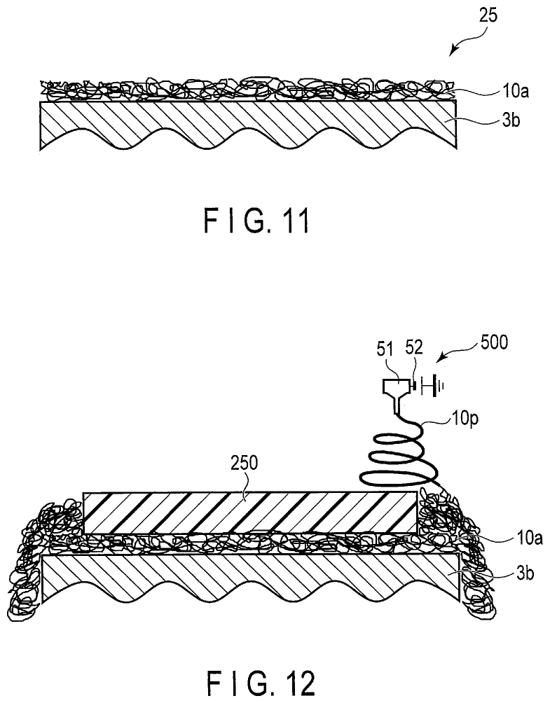

Thus, a stack 25 shown in FIG. 11 for example is obtained. The stack 25 is a stack of the electrode 3 and the organic fiber 10a. In FIG. 11, for the sake of simplicity, only the active material-containing layer 3b is illustrated regarding the electrode 3.

The applied voltage is appropriately determined according to solvent/solute species, boiling point/vapor pressure curves of the solvent, solution concentration, temperature, nozzle shape, distance between the sample and the nozzle, and the like. For example, the applied voltage sets a potential difference between the nozzle and the work to 0.1 kV to 100 kV. The supply rate of the raw material solution is also appropriately determined according to a solution concentration, a solution viscosity, a temperature, a pressure, an applied voltage, a nozzle shape, and the like. When the spinning nozzle 51 is a syringe type, for example, the supply rate is set to 0.1 μl/min to 500 μl/min per nozzle. In addition, when the spinning nozzle 51 is a multi-nozzle or a slit, the supply rate is determined according to an opening area of the nozzle.

Next, a pressing process is performed for the stack 25 of the electrode 3 and the organic fiber 10a, which is thus formed. The pressing process increases the adhesion between the organic fiber 10a and the active material-containing layer 3b, and makes it difficult to peel off the organic fiber 10a from the active material-containing layer 3b. The organic fiber layer 10 is formed by the pressing process. A method of the pressing may be roll press, or may be flat press. A pressing temperature is set, for example, to 20° C. to 200° C. It is preferable to perform this pressing so that a ratio t1/t0 of a thickness t1 of the stack after the pressing to a thickness t0 of the stack before the pressing, that is, a compression ratio is in a range of 60% or more and 98% or less. Specifically, the pressing is performed so that a compression ratio of the first regions 11 included in the organic fiber layer 10 is, for example, in a range of 60% or more and 75% or less, and that a compression ratio of the second region 12 included therein is, for example, in a range of larger than 75% and 98% or less.

The roll press as an example of the pressing process will be described with reference to FIGS. 8 to 10.

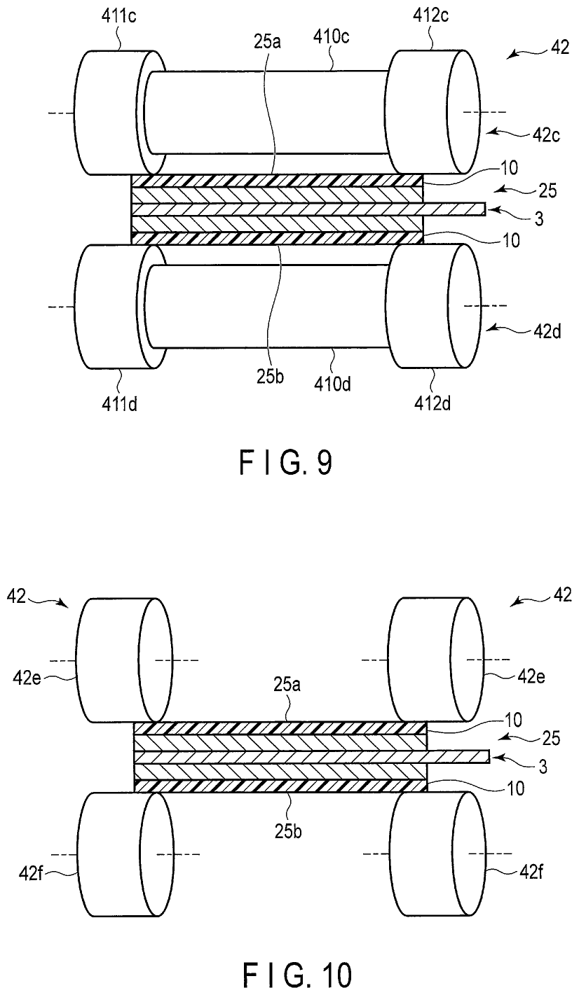

The roll press is performed, for example, by using a pair of press rollers which sandwich the stack 25 therebetween. The stack 25 is formed, for example, by stacking the electrode 3 and the organic fiber layers 10 (organic fiber 10a) on each other. FIG. 8 is a schematic view schematically showing a first pressing step. FIG. 9 is a schematic view schematically showing an example of a second pressing step. FIG. 10 is a schematic view schematically showing another example of the second pressing step. In the stack 25 shown in FIG. 8, the organic fiber 10a that lies off the active material-containing layer 3b is removed in advance. Further, herein, in the stack 25 as a pressing target, such organic fiber 10a is deposited on both surfaces of the electrode 3.

First, the stack 25 is sent to the first pressing step. In the first pressing step, the entire main surface of the stack 25 is pressurized. As shown in FIG. 8, the stack 25 is pressurized, for example, by using a pair of press rollers 42 including a press roller 42a and a press roller 42b. Both of the press rollers 42a and 42b have a cylindrical shape. The press roller 42a is provided on a first surface 25a of the stack 25. The press roller 42b is provided on a second surface 25b of the stack 25. In a state of sandwiching the electrode 3 on which the organic fiber layers 10 are deposited, that is, sandwiching the stack 25, the press roller 42a and the press roller 42b rotate in directions of arrows, thereby pressuring the first and second surfaces 25a and 25b of the stack 25.

The stack 25 already subjected to the first pressing step is then sent to the second pressing step. In the second pressing step, only the portions in the organic fiber layers 10 provided on the stack 25, the portions corresponding to the peripheral edge portions thereof, are pressurized. Then, the peripheral edge portions pressurized in this stage can constitute the first regions denser than the unpressurized second regions.

The second pressing step according to an example is performed, for example, by using press rollers 42c and 42d shown in FIG. 9. Each of the press rollers 42c and 42d has a cylindrical shape in which both end portions along a rotation axis are expanded in diameter. The press roller 42c includes: a cylindrical shaft portion 410c; and diameter-expanded portions 411c and 412c having a larger diameter than a diameter of the shaft portion 410c. The press roller 42d includes: a cylindrical shaft portion 410d; and diameter-expanded portions 411d and 412d having a larger diameter than a diameter of the shaft portion 410d.

Like the first pressing step, the second pressing step shown in FIG. 9 is performed except for using the press rollers 42c and 42d instead of using the press rollers 42a and 42b. Only the diameter-expanded portions 411c and 412c provided in the press roller 42c contact the first surface 25a of the stack 25, and pressurize the organic fiber layer 10 provided on the first surface 25a. Likewise, only the diameter-expanded portions 411d and 412d provided in the press roller 42d contact the second surface 25b of the stack 25, and pressurize the organic fiber layer 10 provided on the second surface 25b. Thus, only the portions in the organic fiber layers 10 provided on both surfaces of the stack 25, the portions corresponding to the peripheral edge portions thereof, are pressurized to constitute the first regions. As a result, the electrode structure 20 described, for example, with reference to FIG. 5 is produced.

A second pressing step according to another example is performed by using a plurality of press rollers 42, for example, as shown in FIG. 10. Each of two sets of the press rollers 42 includes press rollers 42e and 42f. Both of the press rollers 42e and 42f have a cylindrical shape. Each of the two sets of press rollers 42 pressurizes only the portions in the organic fiber layers 10 provided on both surfaces of the stack 25, the portions corresponding to the peripheral edge portions thereof, and constitutes the first regions. As a result, the electrode structure 20 described, for example, with reference to FIG. 5 is produced.

The first pressing step and the second pressing step may be performed by using the flat press instead of the roll press.

(Second Manufacturing Method)

Alternatively, the electrode structure 20 can also be manufactured by a second manufacturing method to be described below. The second manufacturing method will be described with reference to FIGS. 11 and 12. FIG. 12 is a cross-sectional view schematically showing a state in which a part of the stack 25 shown in FIG. 11 is shielded by a mask, and the organic fiber 10a is then further deposited.

First, by a similar method to that described in the first manufacturing method, as shown in FIG. 11, the organic fiber 10a is deposited on the entire surface of the active material-containing layer 3b. At this point of time, the organic fiber 10a is deposited substantially uniformly over the entire surface of the active material-containing layer 3b.

Next, a mask 250 is placed on a part of the main surface of the active material-containing layer 3b with the organic fiber 10a interposed therebetween so as to face the part. A position where the mask 250 is placed is set to be, for example, a position corresponding to the central region of the main surface of the active material-containing layer 3b. In other words, such a placed position of the mask is set to be a position corresponding to the central region of the main surface of the organic fiber 10a deposited by the first deposition step. Hence, the entire surface of the main surface of the mask 250 faces the active material-containing layer 3b with the organic fiber 10a interposed therebetween. Meanwhile, the entire surface of the main surface of the active material-containing layer 3b has a peripheral edge region that does not face the mask 250. In the deposited organic fiber 10a, a portion thereof provided on this peripheral edge region constitutes the first region of the organic fiber layer in the obtained electrode structure.

Then, as shown in FIG. 12, the organic fiber 10a is further deposited on such a portion on the organic fiber 10a, which is not shielded by the mask 250 (a second deposition step). By the second deposition step, there increases the mass per unit area of the organic fiber 10a at the position that is not shielded by the mask 250.

Thereafter, the mask 250 is removed, and the above-mentioned first pressing step is implemented. That is, the entre main surface of the stack 25 is pressurized by substantially the same pressure. The organic fiber layer 10 provided in the electrode structure formed after the pressurization has, for example, the structure described with reference to FIGS. 1 and 2. Note that the organic fiber 10a that lies off the active material-containing layer 3b in the second deposition step may be removed or does not need to be removed by stamping the stack 25 by a mold or the like, for example, after the first pressing step. The obtained electrode structure can be one in which the whole of the organic fiber layer 10 has substantially the same thickness, and the density D1 of the first regions 11 corresponding to the peripheral edge portion is higher than the density D2 of the second region 12 corresponding to the central region. In the second manufacturing method, the second pressing step of pressurizing only the peripheral edge portion of the stack 25 can be omitted; however, the second pressing step may be further performed.

In the second manufacturing method, the ratio M1/M2 of the mass per unit area M1 of the first region with respect to the mass per unit area M2 of the second region is larger than 1.0. Therefore, it is possible to omit the second pressing step as described above, and accordingly, productivity of the electrode structure can be enhanced.

Note that the electrode structure obtained after the pressing process according to the first manufacturing method or the second manufacturing method may be conveyed by rolls and wound around a reel. In accordance with the electrode structure according to the embodiment, the peel off of the organic fiber layer, which may occur at the time of such a roll conveyance, can be suppressed. Therefore, use of the electrode structure according to the embodiment can enhance the productivity of the electrode structure.

In accordance with the first embodiment described above, the electrode structure is provided. The electrode structure includes: the current collector; the active material-containing layer provided on at least one surface of the current collector; and the organic fiber layer provided on the active material-containing layer. The organic fiber layer includes: the first region facing the active material-containing layer; and the second region adjacent to the first region, present on the center side of the main surface of the organic fiber layer, and facing the active material-containing layer. The outer edge of the first region included in the organic fiber layer overlaps the outline of the main surface of the active material-containing layer along the stack direction of the active material-containing layer and the organic fiber layer. The density D1 of the first region of the organic fiber layer is higher than the density D2 of the second region of the organic fiber layer. The organic fiber layer is excellent in adhesion to the active material-containing layer in the first region, and therefore, can suppress the peel off of the organic fiber layer in the electrode edge portion. Further, the second region of the organic fiber layer is less likely to inhibit the ion conduction. Hence, the electrode structure according to the embodiment is capable of achieving the secondary battery with low resistance and suppressed self-discharge.

### Second Embodiment

According to a second embodiment, there is provided a secondary battery including the electrode structure according to the first embodiment, a counter electrode, and an electrolyte.

An electrode structure and a counter electrode can constitute an electrode group. An electrolyte can be held in the electrode group. A secondary battery may further include a self-supporting film type separator disposed between the electrode structure and the counter electrode.

The secondary battery can further include a container member that houses the electrode group and the electrolyte. The secondary battery can further include a negative electrode terminal electrically connected to the negative electrode, and a positive electrode terminal electrically connected to the positive electrode.

The secondary battery can be, for example, a lithium secondary battery. Further, the secondary battery includes a nonaqueous electrolyte secondary battery including a nonaqueous electrolyte.

Hereinafter, the counter electrode, the electrode group, the electrolyte, the self-supporting film type separator, and the container member will be described in detail.

(Counter Electrode)

The counter electrode faces the electrode structure according to the first embodiment. Hereinafter, the electrode included in the electrode structure according to the first embodiment will be described as a first electrode, and the counter electrode will be described as a second electrode.

When the first electrode is the negative electrode, the second electrode can be the positive electrode. When the first electrode is the positive electrode, the second electrode can be the negative electrode.

As in the first embodiment, the second electrode may be an electrode structure including a separator with an integrated electrode. Herein, the separator provided in the second electrode may be, for example, the organic fiber layer according to the first embodiment, or may be an insulating particle layer containing insulating particles. The first electrode and the second electrode may face each other, for example, in a state in which the organic fiber layer on the first electrode and the insulating particle layer on the second electrode are in contact with each other.

The insulating particle layer is provided, for example, between the counter electrode and the organic fiber layer provided in the electrode structure. For example, the insulating particle layer is formed so as to be integrated with the counter electrode. The insulating particle layer is insulating. The insulating particle layer preferably has conductivity of alkali metal ions such as lithium ions.

A part of the main surface of the active material-containing layer may be coated with the insulating particle layer, or the whole of the main surface of the active material-containing layer may be coated with the insulating particle layer. Further, at least a part of the side surface of the active material-containing layer, which is adjacent to the main surface thereof may be coated with the insulating particle layer.

The insulating particle layer contains, for example, an inorganic compound. Examples of the inorganic compound can include: oxides (for example, oxides of Groups IIA to VA, transition metals, IIIB, IVB such as Li₂O, BeO, B₂O₃, Na₂O, MgO, Al₂O₃, SiO₂, P₂O₅, CaO, Cr₂O₃, Fe₂O₃, ZnO, ZrO₂, TiO₂, magnesium oxide, silicon oxide, alumina, zirconia, and titanium oxide); zeolites (M₂/ₙO.Al₂O₃.xSiO₂.yH₂O (where M is an atom of metal such as Na, K, Ca, and Ba, n is the number equivalent to electric charges of metal cations Mn⁺, and x and y are molar numbers of SiO₂ and H₂O, where 2≤x≤10, 2≤y)); nitrides (for example, BN, AlN, Si₃N₄, Ba₃N₂, and the like); silicon carbide (SiC), zircon (ZrSiO₄), carbonates (for example, MgCO₃ and CaCO₃, and the like), sulfates (for example, CaSO₄, BaSO₄, and the like), and composites of these (for example, steatite (MgO.SiO₂), forsterite (2MgO.SiO₂), cordierite (2MgO.2Al₂O₃.5SiO₂), each of which is a type of porcelain; tungsten oxide; or mixtures of these.

Examples of other inorganic compounds can include barium titanate, calcium titanate, lead titanate, γ-LiAlO₂, LiTiO₃, or mixtures of these. The insulating particle layer preferably contains alumina.

A form of the inorganic compound is, for example, particulate or fibrous. An average particle size D50 of the inorganic compound is, for example, 0.5 μm or more and 2 μm or less.

The insulating particle layer may contain an additive such as a binder as well as the inorganic compound. Examples of the binder can include carboxymethylcellulose, polyvinylidenefluoride, polyimide, polyamideimide, a styrene-butadiene copolymer, and an acrylic synthetic resin.

An occupation ratio of the inorganic compound in the insulating particle layer is preferably 50 mass % or more and 95 mass % or less.

A thickness of the insulating particle layer is, for example, 0.2 μm or more and 40 μm or less.

This insulating particle layer can be provided by stacking the inorganic compound on the active material-containing layer, for example, by a sputtering method or a chemical vapor deposition (CVD) method. This insulating particle layer may also be provided by applying slurry containing the inorganic compound to the active material-containing layer, followed by drying.

Note that, in the electrode structure according to the above-mentioned first embodiment, the insulating particle layer may be provided between the first electrode and the organic fiber layer. In this case, an outline of the main surface of the insulating particle layer and the outline of the main surface of the organic fiber layer may coincide with each other in a stack direction of these. Then, the organic fiber layer provided on the insulating particle layer may include the first region and the second region as described in the first embodiment. In the electrode structure, when the insulating particle layer is provided between the organic fiber layer and the active material-containing layer, the internal short circuit of the secondary battery can be made less likely to occur. That is, the insulating particle layer can function as the separator together with the organic fiber layer deposited on the insulating particle layer. Hence, insulating properties are kept even if a part of the organic fiber layer is peeled off from the insulating particle layer, and accordingly, the internal short circuit of the secondary battery is less likely to occur.

(Electrode Group)

FIG. 13 is a cross-sectional view schematically showing an example of the electrode group. An electrode group 1 shown in FIG. 13 includes the electrode structure 20 and a second electrode 5. The electrode structure 20 includes the first electrode 3, and the organic fiber layers 10 stacked on both surfaces of the first electrode 3. The electrode structure 20 and the second electrode 5 face each other with the organic fiber layer 10 sandwiched therebetween, the organic fiber layer 10 being provided in the electrode structure 20. In FIG. 13, an X-direction and a Y-direction are directions perpendicular to each other, and a Z-direction is a direction perpendicular to the X-direction and the Y-direction.

The second electrode 5 includes: a current collector 5a; active material-containing layers 5b provided on both surfaces of the current collector 5a; and a current-collecting tab 5c that is not provided with the active material-containing layers 5b in the current collector 5a. Such an active material-containing layer 5b may be provided on one surface of the current collector 5a. In the electrode group shown in FIG. 13, the current-collecting tab 3c of the first electrode 3 and the current-collecting tab 5c of the second electrode 5 protrude in directions opposite to each other, for example, along the X-direction. Though not illustrated, the electrode structure 20 and the second electrode 5 may be stacked on each other so that the current-collecting tabs thereof protrude in the same direction.

In the example shown in FIG. 13, a length of the first electrode 3 (active material-containing layers 3b) in the X-direction is larger than a length of the second electrode 5 (active material-containing layers 5b) in the X-direction. Following this, in the X-direction, a length of the organic fiber layers 10 is larger than a length of the active material-containing layers 5b provided in the second electrode 5. Then, both of edge portions 5e₁ and 5e₂ provided in the active material-containing layers 5b are located on the first region 11 provided in the organic fiber layer 10. The first regions 11 are denser than the second regions 12. Therefore, when the edge portions 5e₁ and 5e₂ of the second electrode 5 as the counter electrode are located on the first region 11, the internal short circuit caused by the edge portions is less likely to occur. As a result, the self-discharge amount can be reduced. This effect is obtained by the fact that at least one of the edge portions 5e₁ and 5e₂ is present on the first region 11. The edge portions 5e₁ and 5e₂ may be located on the second region 12, and do not need to be located on the organic fiber layer 10.

FIG. 14 is a cross-sectional view schematically showing another example of the electrode group. The electrode group 1 shown in FIG. 14 includes the electrode structure 20 shown in FIG. 13, and a counter electrode structure 27. The counter electrode structure 27 includes the second electrode 5, and an insulating particle layer 26 provided on the active material-containing layer 5b. In FIG. 14, the insulating particle layer 26 is provided on only one surface of the second electrode 5; however, such insulating particle layers 26 may be provided on both surfaces of the second electrode 5. The electrode structure 20 and the counter electrode structure 27 face each other with the organic fiber layer 10 and the insulating particle layer 26 sandwiched therebetween, which are provided on the first electrode 3 and the second electrode 5, respectively. In this case, the internal short circuit between the positive and negative electrodes can be suppressed more than in the case where the electrode group 1 does not include the insulating particle layer 26, and accordingly, the self-discharge amount can be reduced.

(Electrolyte)

A nonaqueous electrolyte can be used as the electrolyte. Examples of the nonaqueous electrolyte include a liquid nonaqueous electrolyte prepared by dissolving an electrolyte salt in an organic solvent, a gel-form nonaqueous electrolyte in which a liquid electrolyte and a polymer material are combined, and the like. The liquid nonaqueous electrolyte can be prepared by, for example, dissolving an electrolyte salt in an organic solvent at a concentration of 0.5 mol/L to 2.5 mol/L.

Examples of the electrolyte salt can include a lithium salt such as lithium perchlorate (LiClO₄), lithium hexafluorophosphate (LiPF₆), lithium tetrafluoroborate (LiBF₄), lithium arsenic hexafluoride (LiAsF₆), lithium trifluoromethanesulfonate (LiCF₃SO₃), or bistrifluoromethylsulfonylimide lithium [LiN(CF₃SO₂)₂], and mixtures thereof. As the electrolyte salt, those difficult to be oxidized even at a high potential are preferable, and LiPF₆ is most preferable.

Examples of the organic solvent include cyclic carbonates such as propylene carbonate (PC), ethylene carbonate (EC), and vinylene carbonate, chain carbonates such as diethyl carbonate (DEC), dimethyl carbonate (DMC), and methyl ethyl carbonate (MEC), cyclic ethers such as tetrahydrofuran (THF), 2 methyl tetrahydrofuran (2MeTHF), and dioxolane (DOX), chain ethers such as dimethoxy ethane (DME) and diethoxy ethane (DEE), γ-butyrolactone (GBL), acetonitrile (AN), and sulfolane (SL). These organic solvents can be used alone or can be used as a mixture of two or more kinds.

Examples of the polymer material can include polyvinylidene fluoride (PVdF), polyacrylonitrile (PAN), polyethylene oxide (PEO), or mixtures thereof.

As the nonaqueous electrolyte, an room temperature molten salt (ionic melt) containing lithium ions, a polymer solid electrolyte, an inorganic solid electrolyte, or the like may be used.

(Container Member)

As the container member, for example, a metal container, a container made of a laminate film, or the like can be used.

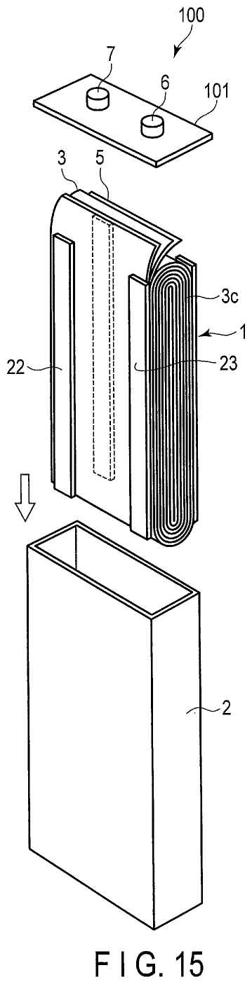

FIG. 15 is an exploded perspective view showing an example of the secondary battery according to the embodiment. FIG. 15 is a view showing an example of a secondary battery using a rectangular metal-made container as a container member. A secondary battery 100 shown in FIG. 15 includes: a container member 2; a winding-type electrode group 1; a lid 101; a positive electrode terminal 7; a negative electrode terminal 6; a nonaqueous electrolyte (not shown); a positive electrode lead 22; and a negative electrode lead 23. A description will be given below on the assumption that the first electrode 3 is a negative electrode, and that the second electrode 5 is a positive electrode.

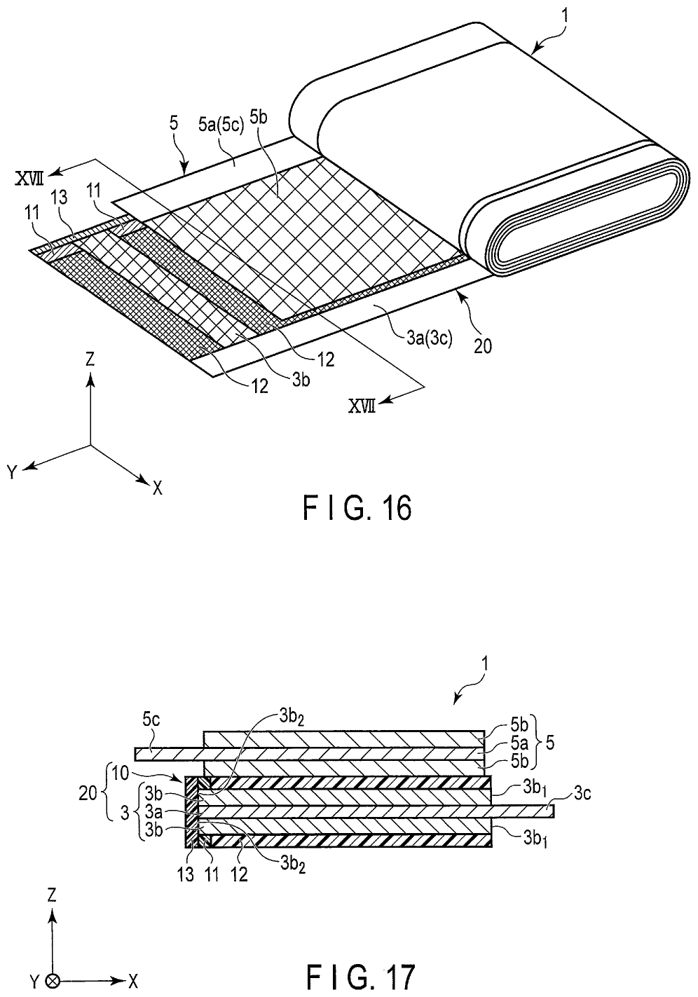

FIG. 16 is a partially developed perspective view of the winding-type electrode group 1. FIG. 17 is a cross-sectional view schematically showing a cross section taken along a line XVII-XVII of the winding-type electrode group 1, which is shown in FIG. 16. The flat winding-type electrode group 1 is one formed in such a manner that the electrode structure 20 and the positive electrode 5 as the second electrode are stacked on each other and wound into a flat shape. A winding axis extends, for example, in a direction parallel to the X-direction. The electrode structure 20 includes the negative electrode 3 as the first electrode, and the organic fiber layers 10. The negative electrode 3 includes: the belt-shaped negative electrode current collector 3a made, for example, of metal foil; the negative electrode tab 3c formed of one end portion parallel to the long sides of the negative electrode current collector 3a; and the negative electrode active material-containing layers 3b formed on the negative electrode current collector 3a except at least the portion of the negative electrode tab 3c.

The organic fiber layers 10 includes the first regions 11, the second regions 12, and the third regions 13. In the example shown in FIGS. 16 and 17, the negative electrode tab 3c protrudes along the X-direction. The active material-containing layers 3b provided into an elongated and belt shape include: side surfaces 3b1 along long sides on which the negative electrode tab 3c protrudes; and side surfaces 3b₂ along long sides on which the negative electrode tab 3c does not protrude. The first regions 11 included in the organic fiber layer 10 extend along the Y-direction so that outer edges thereof overlap the side surfaces 3b2 of the active material-containing layers 3b. In the example shown in FIGS. 16 and 17, the first regions 11 are not provided on the long side from which the negative electrode tab 3c protrudes. However, the first regions 11 may be provided on the long side from which the negative electrode tab 3c protrudes. The third regions 13 are provided continuously with the first regions 11, and the side surface of the current collector 3a and the side surfaces 3b2 of the active material-containing layers 3b are coated with the third regions.

The positive electrode 5 includes: the belt-shaped positive electrode current collector 5a made, for example, of metal foil; the positive electrode current-collecting tab 5c formed of one end portion parallel to the long sides of the positive electrode current collector; and the positive electrode active material-containing layers 5b formed on the positive electrode current collector 5a except the portion of the positive electrode current-collecting tab 5c.

The positive electrode 5 and the electrode structure 20 are wound while shifting the positions of the positive electrode 5 and the negative electrode 3 from each other so that the positive electrode current collector 5a protrudes from the organic fiber layer 10 in a winding axis direction of the electrode group 1, and that the negative electrode current collector 3a protrudes from the organic fiber layer 10 in a direction opposite thereto. By such winding, as shown in FIG. 16, in the electrode group 1, the positive electrode current-collecting tab 5c wound in a swirl shape protrudes from one end surface thereof, and the negative electrode tab 3c wound in a swirl shape protrudes from the other end surface.

As shown in FIG. 15, in the winding-type electrode group 1, the positive electrode current-collecting tab (not shown) wound in a flat swirl shape is located on one end surface in a circumferential direction, and the negative electrode tab 3c wound in a flat swirl shape is located on the other end surface therein. The nonaqueous electrolyte is held or impregnated in the electrode group 1. The positive electrode lead 22 is electrically connected to the positive electrode tab, and is also electrically connected to the positive electrode terminal 7. Further, the negative electrode lead 23 is electrically connected to the negative electrode tab 3c, and is also electrically connected to the negative electrode terminal 6. The electrode group 1 is disposed in the container member 2 so that the positive electrode lead 22 and the negative electrode lead 23 face the main surface of the container member 2. The lid 101 is fixed to an opening portion of the container member 2 by welding or the like. Each of the positive electrode terminal 7 and the negative electrode terminal 6 is attached to the lid 101 with an insulating hermetic seal member (not shown) interposed therebetween.

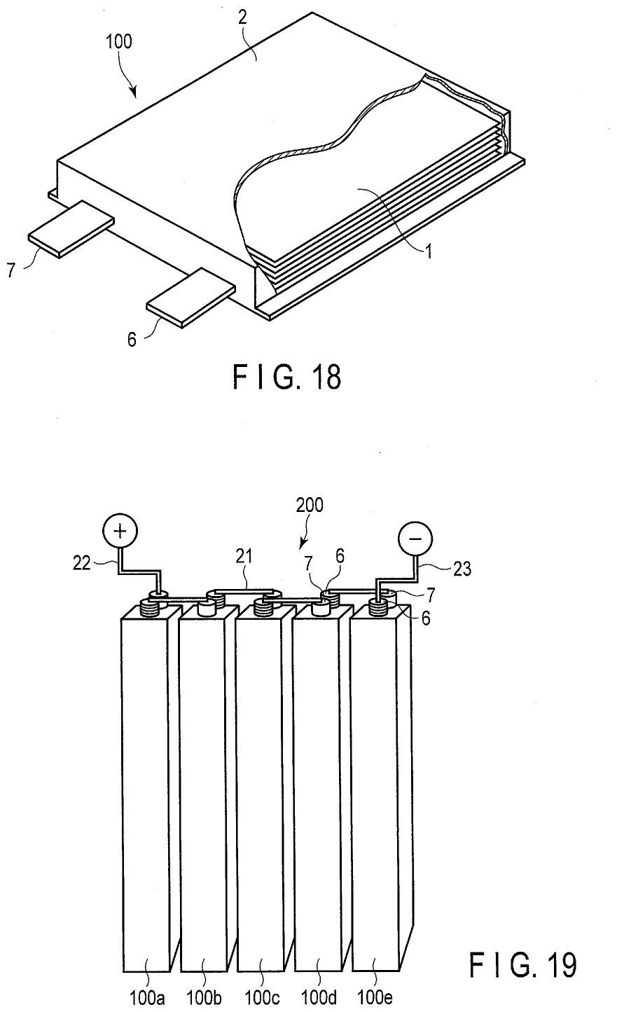

FIG. 18 is a partially cutaway perspective view showing another example of the secondary battery according to the embodiment. FIG. 18 is a view showing an example of a secondary battery using a laminated film as a container member. A secondary battery 100 shown in FIG. 18 includes: a container member 2 made of a laminated film; the electrode group 1; the positive electrode terminal 7; the negative electrode terminal 6; and a nonaqueous electrolyte (not shown). The electrode group 1 has a stack structure in which a plurality of the electrode structures according to the embodiment and a plurality of the counter electrodes are alternately stacked on each other. The nonaqueous electrolyte (not shown) is held or impregnated in the electrode group 1. Though not shown, the positive electrode tabs of the respective positive electrodes are electrically connected to the positive electrode terminal 7, and the negative electrode tabs of the respective negative electrodes are electrically connected to the negative electrode terminal 6. In a state of being spaced apart from each other, the positive electrode terminal 7 and the negative electrode terminal 6 individually have tip ends thereof protrude to the outside of the container member 2.

The secondary battery according to the second embodiment includes the electrode structure according to the first embodiment. Hence, the secondary battery according to the second embodiment has low resistance and can suppress the self-discharge.

### Third Embodiment

According to a third embodiment, a battery module is provided. The battery module according to the third embodiment includes plural secondary batteries according to the second embodiment.

In the battery module according to the embodiment, each of the single batteries may be arranged electrically connected in series, in parallel, or in a combination of in-series connection and in-parallel connection.

An example of the battery module according to the fourth embodiment will be described next with reference to the drawings.

FIG. 19 is a perspective view schematically showing an example of the battery module according to the embodiment. A battery module 200 shown in FIG. 19 includes five single-batteries 100a to 100e, four bus bars 21, a positive electrode-side lead 22, and a negative electrode-side lead 23. Each of the five single-batteries 100a to 100e is a secondary battery according to the second embodiment.

The bus bars 21 connects a negative electrode terminal 6 of a single unit cell 100a to a positive electrode terminal 7 of an adjacently positioned unit cell 100b. In this way, the five unit cells 100a to 100e are connected in series by the four bus bars 21. That is, the battery module 200 shown in FIG. 19 is a battery module of five in-series connection. Although an example is not illustrated, in a battery module containing a plurality of unit cells electrically connected in parallel, the plurality of unit cells may be electrically connected by connecting the plurality of negative electrode terminals to each other with busbars and also connecting the plurality of positive electrode terminals to each other with busbars, for example.

The positive electrode terminal 7 of at least one battery among the five unit cells 100a to 100e is electrically connected to a positive electrode lead 22 for external connection. Also, the negative electrode terminal 6 of at least one battery among the five unit cells 100a to 100e is electrically connected to a negative electrode lead 23 for external connection.

An battery module according to a third embodiment includes the secondary battery according to the second embodiment. Hence, the battery module according to the third embodiment has low resistance and can suppress the self-discharge.

### Fourth Embodiment

According to the fourth embodiment, a battery pack is provided. The battery pack includes the battery module according to the third embodiment. The battery pack may also be equipped with a single secondary battery according to the second embodiment instead of the battery module according to the third embodiment.

The battery pack according to the embodiment may further include a protective circuit. The protective circuit has a function to control charging and discharging of the secondary battery. Alternatively, a circuit included in equipment where the battery pack serves as a power source (for example, electronic devices, vehicles, and the like) may be used as the protective circuit for the battery pack.

Moreover, the battery pack according to the embodiment may further include an external power distribution terminal. The external power distribution terminal is configured to externally output current from the secondary battery, and to input external current into the secondary battery. In other words, when the battery pack is used as a power source, the current is provided out via the external power distribution terminal. When the battery pack is charged, the charging current (including regenerative energy of a motive force of vehicles such as automobiles) is provided to the battery pack via the external power distribution terminal.

Next, an example of a battery pack according to the embodiment will be described with reference to the drawings.

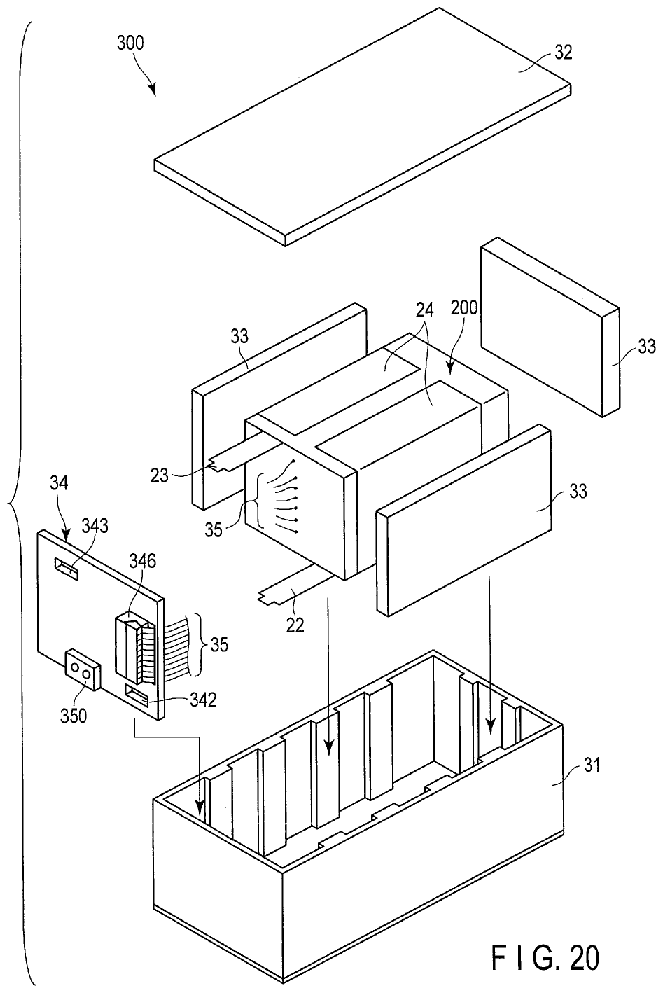

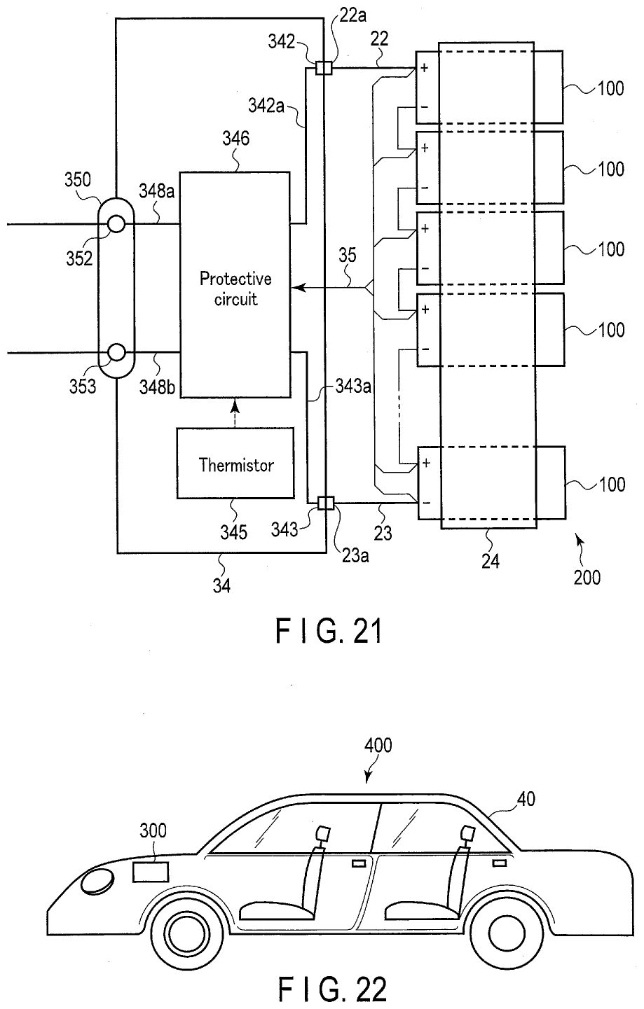

FIG. 20 is an exploded perspective view schematically showing an example of the battery pack according to the embodiment. FIG. 21 is a block diagram showing an example of an electric circuit of the battery pack shown in FIG. 20.

A battery pack 300 shown in FIGS. 20 and 21 includes a housing container 31, a lid 32, protective sheets 33, a battery module 200, a printed wiring board 34, wires 35, and an insulating plate (not shown).

A housing container 31 shown in FIG. 20 is a bottomed-square-shaped container having a rectangular bottom surface. The housing container 31 is configured to house protective sheet 33, a battery module 200, a printed wiring board 34, and wires 35. A lid 32 has a rectangular shape. The lid 32 covers the housing container 31 to house the battery module 200 and the like. Although not shown, opening(s) or connection terminal(s) for connecting to external device(s) and the like are provided on the housing container 31 and lid 32.

The battery module 200 includes plural unit cells 100, a positive electrode-side lead 22, a negative electrode-side lead 23, and an adhesive tape 24.

At least one in the plurality of unit cells 100 is a secondary battery according to the second embodiment. Each unit cell 100 in the plurality of unit cells 100 is electrically connected in series, as shown in FIG. 21. The plurality of unit cells 100 may alternatively be electrically connected in parallel, or connected in a combination of in-series connection and in-parallel connection. If the plurality of unit cells 100 is connected in parallel, the battery capacity increases as compared to a case where they are connected in series.

The adhesive tape 24 fastens the plural unit cells 100. The plural unit cells 100 may be fixed using a heat-shrinkable tape in place of the adhesive tape 24. In this case, the protective sheets 33 are arranged on both side surfaces of the battery module 200, and the heat-shrinkable tape is wound around the battery module 200 and protective sheets 33. After that, the heat-shrinkable tape is shrunk by heating to bundle the plural unit cells 100.

One terminal of a positive electrode lead 22 is connected to a battery module 200. One terminal of the positive electrode lead 22 is electrically connected to the positive electrode of one or more unit cells 100. One terminal of a negative electrode lead 23 is connected to the battery module 200. One terminal of the negative electrode lead 23 is electrically connected to the negative electrode of one or more unit cells 100.

The printed wiring board 34 is arranged on the inner surface of the housing container 31 along the short side direction. The printed wiring board 34 includes a positive electrode connector 342, a negative electrode connector 343, a thermistor 345, a protective circuit 346, wirings 342a and 343a, an external power distribution terminal 350, a plus-side wire (positive-side wire) 348a, and a minus-side wire (negative-side wire) 348b. One principal surface of the printed wiring board 34 faces one side surface of the battery module 200. An insulating plate (not shown) is disposed in between the printed wiring board 34 and the battery module 200.

The other terminal 22a of the positive electrode lead 22 is electrically connected to a positive electrode connector 342. The other terminal 23a of the negative electrode lead 23 is electrically connected to a negative electrode connector 343.

The thermistor 345 is fixed to one principal surface of the printed wiring board 34. The thermistor 345 detects the temperature of each unit cell 100 and transmits detection signals to the protective circuit 346.

The external power distribution terminal 350 is fixed to the other principal surface of the printed wiring board 34. The external power distribution terminal 350 is electrically connected to device(s) that exists outside the battery pack 300. The external power distribution terminal 350 includes a positive side terminal 352 and a negative side terminal 353.

The protective circuit 346 is fixed to the other principal surface of the printed wiring board 34. The protective circuit 346 is connected to the positive side terminal 352 via the plus-side wire 348a. The protective circuit 346 is connected to the negative side terminal 353 via the minus-side wire 348h. In addition, the protective circuit 346 is electrically connected to the positive electrode connector 342 via the wiring 342a. The protective circuit 346 is electrically connected to the negative electrode connector 343 via the wiring 343a. Furthermore, the protective circuit 346 is electrically connected to each unit cell 100 in the plurality of unit cells 100 via the wires 35.

The protective sheets 33 are arranged on both inner surfaces of the housing container 31 along the long side direction and on one inner surface of the housing container 31 along the short side direction facing the printed wiring board 34 through the battery module 200. The protective sheet 33 is made of, for example, resin or rubber.

The protective circuit 346 controls charging and discharging of the plurality of unit cells 100. The protective circuit 346 is also configured to cut off electric connection between the protective circuit 346 and the external power distribution terminal 350 (the positive side terminal 352 and the negative side terminal 353) to the external devices, based on detection signals transmitted from the thermistor 345 or detection signals transmitted from each unit cell 100 or the battery module 200.

An example of the detection signal transmitted from the thermistor 345 is a signal indicating that the temperature of the unit cell(s) 100 is detected to be a predetermined temperature or more. An example of the detection signal transmitted from each unit cell 100 or the battery module 200 is a signal indicating detection of over-charge, over-discharge, and overcurrent of the unit cell(s) 100. When detecting over-charge or the like for each of the unit cells 100, the battery voltage may be detected, or a positive electrode potential or negative electrode potential may be detected. In the latter case, a lithium electrode to be used as a reference electrode may be inserted into each unit cell 100.

Note, that as the protective circuit 346, a circuit included in a device (for example, an electronic device or an automobile) that uses the battery pack 300 as a power source may be used.

As described above, the battery pack 300 includes the external power distribution terminal 350. Hence, the battery pack 300 can output current from the battery module 200 to an external device and input current from an external device to the battery module 200 via the external power distribution terminal 350. In other words, when using the battery pack 300 as a power source, the current from the battery module 200 is supplied to an external device via the external power distribution terminal 350. When charging the battery pack 300, a charge current from an external device is supplied to the battery pack 300 via the external power distribution terminal 350. If the battery pack 300 is used as an onboard battery, the regenerative energy of the motive force of a vehicle can be used as the charge current from the external device.

Note that the battery pack 300 may include a plurality of battery modules 200. In this case, the plurality of battery modules 200 may be connected in series, in parallel, or connected in a combination of in-series connection and in-parallel connection. The printed wiring board 34 and the wires 35 may be omitted. In this case, the positive electrode lead 22 and the negative electrode lead 23 may be used as the positive side terminal and the negative side terminal of the external power distribution terminal, respectively.

Such a battery pack is used for, for example, an application required to have the excellent cycle performance when a large current is taken out. More specifically, the battery pack is used as, for example, a power source for electronic devices, a stationary battery, or an onboard battery for various kinds of vehicles. An example of the electronic device is a digital camera. The battery pack is particularly favorably used as an onboard battery.

A battery pack according to a fourth embodiment includes the secondary battery according to the second embodiment or the battery module according to the third embodiment. Hence, in accordance with the third embodiment, there can be provided the secondary battery that has low resistance and can suppress the self-discharge or a battery pack including the battery module.

### Fifth Embodiment

According to the fifth embodiment, a vehicle is provided. The vehicle includes the battery pack according to the fourth embodiment.

In a vehicle according to the fifth embodiment, the battery pack is configured, for example, to recover regenerative energy from motive force of the vehicle. The vehicle may include a mechanism configured to convert kinetic energy of the vehicle into regenerative energy.

Examples of the vehicle according to the fifth embodiment include two- to four-wheeled hybrid electric automobiles, two- to four-wheeled electric automobiles, electric assist bicycles, and railway cars.

In the vehicle, the installing position of the battery pack is not particularly limited. For example, the battery pack may be installed in the engine compartment of the vehicle, in rear parts of the vehicle, or under seats.

A plurality of battery packs is loaded on the vehicle. In this case, the batteries included in each of the battery packs may be electrically connected to each other in series, in parallel, or in a combination of in-series connection and in-parallel connection. For example, in the case where each battery pack includes a battery module, the battery modules may be electrically connected to each other in series, in parallel, or in a combination of in-series connection and in-parallel connection. Alternatively, in the case where each battery pack includes a single battery, each of the batteries may be electrically connected to each other in series, in parallel, or in a combination of in-series connection and in-parallel connection.

Next, one example of the vehicle according to the fifth embodiment will be described with reference to the drawings.

FIG. 22 is a partially transparent diagram schematically illustrating one example of a vehicle according to the embodiment.

A vehicle 400 illustrated in FIG. 22 includes a vehicle body 40 and a battery pack 300 according to the embodiment. In the example illustrated in FIG. 22, the vehicle 400 is a four-wheeled automobile.

A plurality of the battery packs 300 may be loaded on the vehicle 400. In this case, the batteries included in the battery packs 300 (for example, unit cell or battery modules) may be connected in series, connected in parallel, or connected in a combination of in-series connection and in-parallel connection.

In FIG. 22, the battery pack 300 is installed in an engine compartment located at the front of the vehicle body 40. As described above, the battery pack 300 may be installed in rear sections of the vehicle body 40, or under a seat. The battery pack 300 may be used as a power source of the vehicle 400. In addition, the battery pack 300 can recover regenerative energy of a motive force of the vehicle 400.

Next, an embodiment of the vehicle according to the sixth embodiment will be described with reference to FIG. 12.

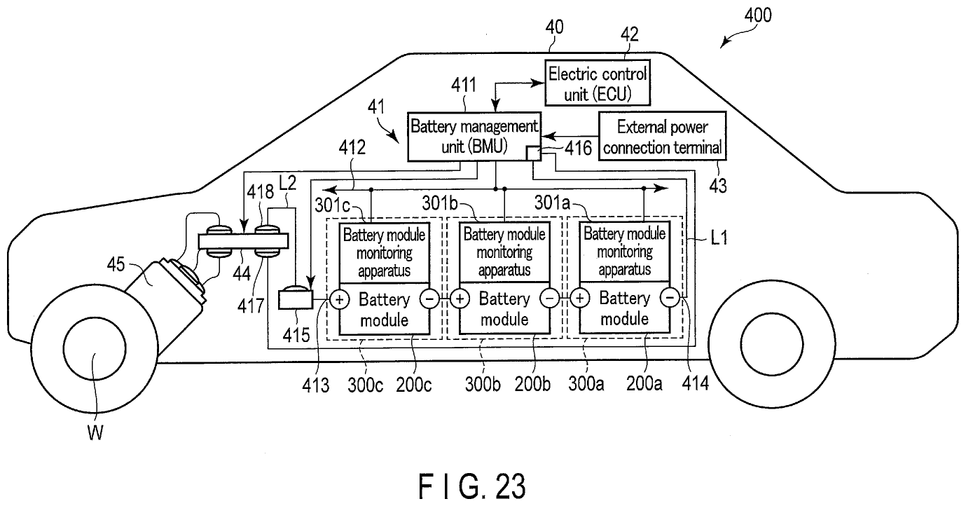

FIG. 23 is a diagram schematically illustrating one example of a control system related to an electrical system in the vehicle according to the fifth embodiment. The vehicle 400 illustrated in FIG. 23 is an electric automobile.

The vehicle 400, shown in FIG. 23, includes a vehicle body 40, a vehicle power source 41, a vehicle ECU (electric control unit) 42, which is a master controller of the vehicle power source 41, an external terminal (an external power connection terminal) 43, an inverter 44, and a drive motor 45.

The vehicle 400 includes the vehicle power source 41, for example, in the engine compartment, in the rear sections of the automobile body, or under a seat. In FIG. 23, the position of the vehicle power source 41 installed in the vehicle 400 is schematically shown.

The vehicle power source 41 includes plural (for example, three) battery packs 300a, 300b and 300c, a battery management unit (BMU) 411, and a communication bus 412.

A battery pack 300a is provided with a battery module 200a and a battery module monitoring apparatus 301a (for example, voltage temperature monitoring (VTM)). A battery pack 300b is provided with a battery module 200b and a battery module monitoring apparatus 301b. A battery pack 300c is provided with a battery module 200c and a battery module monitoring apparatus 301c. The battery packs 300a to 300c are battery packs similar to the battery pack 300 described earlier, and the battery modules 200a to 200c are battery modules similar to the battery module 200 described earlier. The battery modules 200a to 200c are electrically connected in series. The battery packs 300a, 300b, and 300c are removable independently of each other, and each can be replaced with a different battery pack 300.

Each of the battery modules 200a to 200c includes plural battery cells connected in series. At least one of the plural battery cells is the secondary battery according to the second embodiment. The battery modules 200a to 200c each perform charging and discharging via a positive electrode terminal 413 and a negative electrode terminal 414.

A battery management apparatus 411 communicates with the battery module monitoring apparatus 301a to 301c, and collects information related to the voltage, temperature, and the like for each of the unit cells 100 included in the battery modules 200a to 200c included in the vehicle power source 41. With this arrangement, the battery management apparatus 411 collects information related to the maintenance of the vehicle power source 41.

The battery management apparatus 411 and the battery module monitoring apparatus 301a to 301c are connected via a communication bus 412. In the communication bus 412, a set of communication wires are shared with a plurality of nodes (the battery management apparatus 411 and one or more of the battery module monitoring apparatus 301a to 301c). The communication bus 412 is a communication bus, for example, configured in accordance with the controller area network (CAN) standard.

The battery module monitoring units 301a to 301c measure a voltage and a temperature of each battery cell in the battery modules 200a to 200c based on commands from the battery management unit 411. It is possible, however, to measure the temperatures only at several points per battery module, and the temperatures of all of the battery cells need not be measured.

The vehicle power source 41 can also have an electromagnetic contactor (for example, a switch apparatus 415 illustrated in FIG. 23) that switches the presence or absence of an electrical connection between a positive electrode terminal 413 and a negative electrode terminal 414. The switch apparatus 415 includes a pre-charge switch (not illustrated) that turns on when the battery modules 200a to 200c are charged, and a main switch (not illustrated) that turns on when the output from the battery modules 200a to 200c is supplied to the load. Each of the pre-charge switch and the main switch is provided with a relay circuit (not illustrated) that switches on or off according to a signal supplied to a coil disposed near a switching element. The electromagnetic contactor such as the switch apparatus 415 is controlled according to of control signals from the battery management apparatus 411 or the vehicle ECU 42 that controls the entire operation of the vehicle 400.

The inverter 44 converts an inputted direct current voltage to a three-phase alternate current (AC) high voltage for driving a motor. Three-phase output terminal(s) of the inverter 44 is (are) connected to each three-phase input terminal of the drive motor 45. The inverter 44 is controlled based on control signals from the battery management apparatus 411, or the vehicle ECU 42 which controls the entire operation of the vehicle. By controlling the inverter 44, the output voltage from the inverter 44 is adjusted.

The drive motor 45 is rotated by electric power supplied from the inverter 44. The driving force produced by the rotation of the drive motor 45 is transmitted to an axle (or axles) and drive wheels W via a differential gear unit for example.

The vehicle 400 also includes a regenerative brake mechanism (regenerator), though not shown. The regenerative brake mechanism rotates the drive motor 45 when the vehicle 400 is braked, and converts kinetic energy into regenerative energy, as electric energy. The regenerative energy, recovered in the regenerative brake mechanism, is inputted into the inverter 44 and converted to direct current. The converted direct current is inputted into the vehicle power source 41.

One terminal of a connection line L1 is connected to the negative electrode terminal 414 of the vehicle power source 41. The other terminal of the connection line L1 is connected to a negative electrode input terminal 417 of the inverter 44. On the connection line L1, a current detector (current detection circuit) 416 is provided inside the battery management apparatus 411 between the negative electrode terminal 414 and the negative electrode input terminal 417.

One terminal of a connection line L2 is connected to the positive electrode terminal 413 of the vehicle power source 41. The other terminal of the connection line L2 is connected to a positive electrode input terminal 418 of the inverter 44. On the connection line L2, the switch apparatus 415 is provided between the positive electrode terminal 413 and the positive electrode input terminal 418.

The external terminal 43 is connected to the battery management apparatus 411. The external terminal 43 can be connected to, for example, an external power source.

The vehicle ECU 42 cooperatively controls the vehicle power source 41, the switch apparatus 415, the inverter 44, and the like together with other management apparatus and control apparatus, including the battery management apparatus 411, in response to operation input from a driver or the like. By the cooperative control by the vehicle ECU 42 and the like, the output of electric power from the vehicle power source 41, the charging of the vehicle power source 41, and the like are controlled, and the vehicle 400 is managed as a whole. Data related to the maintenance of the vehicle power source 41, such as the remaining capacity of the vehicle power source 41, is transferred between the battery management apparatus 411 and the vehicle ECU 42 by a communication line.

A vehicle according to a fifth embodiment mounts thereon the battery pack according to the fourth embodiment. Hence, in accordance with the fifth embodiment, there can be provided a vehicle including the battery pack that has low resistance and can suppress the self-discharge.

### EXAMPLES

Examples will be described below; however, the embodiments are not limited to the examples to be described below.

### Example 1

(Production of Positive Electrode)

A positive electrode was produced as follows.

First, a positive electrode active material, an electro-conductive agent, and a binder were dispersed into a solvent, and slurry was prepared. Ratios of the positive electrode active material, the electro-conductive agent, and the binder were 93 mass %, 5 mass %, and 2 mass %, respectively. As the positive electrode active material, a lithium nickel cobalt manganese composite oxide (LiNi_{0.5}Co_{0.2}Mn_{0.3}O₂) was used. As the electro-conductive agent, a mixture of acetylene black and carbon black was used. A mass ratio of the acetylene black and the carbon black in the mixture was 2:1. As the binder, polyvinylidenefluoride (PVdF) was used. As the solvent, N-methylpyrrolidone (NMP) was used. Subsequently, the prepared slurry was applied to both surfaces of a positive electrode current collector, and coating films were dried, whereby a positive electrode active material-containing layer was formed. As the positive electrode current collector, aluminum alloy foil with a thickness of 12 μm was used. The aluminum alloy foil has a long belt shape. Subsequently, the positive electrode current collector and the positive electrode active material-containing layer were pressed, and a positive electrode was produced.

(Production of Negative Electrode)

A negative electrode was produced as follows.

First, a negative electrode active material, an electro-conductive agent, and a binder were dispersed into a solvent, and slurry was prepared. Ratios of the negative electrode active material, the electro-conductive agent, and the binder were 95 mass %, 3 mass %, and 2 mass %, respectively. As the negative electrode active material, niobium titanium oxide NTO(Nb₂TiO₇) powder was used. As the electro-conductive agent, a mixture of acetylene black and carbon black was used. A mass ratio of the acetylene black and the carbon black in the mixture was 2:1. As the binder, carboxymethylcellulose was used. As the solvent, water was used. Subsequently, the obtained slurry was applied to both surfaces of a negative electrode current collector, and coating films were dried, whereby a negative electrode active material-containing layer was formed. As the negative electrode current collector, aluminum alloy foil with a thickness of 12 μm was used. The aluminum alloy foil has a long belt shape. Subsequently, the negative electrode current collector and the negative electrode active material-containing layer were pressed, and a negative electrode was obtained.

(Formation of Organic Fiber Layer)

Next, an organic fiber layer was formed on the negative electrode. Specifically, first, polyamideimide was dissolved into dimethylacetoamide, and a raw material solution was prepared. A concentration of the polyamideimide in the raw material solution was 80 mass %. Subsequently, a voltage of 30 kV was applied to a spinning nozzle of an electrospinning device by using a high voltage generator. Subsequently, by using a metering pump, the raw material solution was supplied to the spinning nozzle, and the raw material solution was discharged from the spinning nozzle toward the surfaces of the negative electrode. The spinning nozzle was moved on the surfaces of the negative electrode active material-containing layers, whereby organic fiber layers which cover the entire surfaces of the negative electrode active material-containing layers provided on both surfaces of the negative electrode current collector were formed. Deposition of the organic fiber layers so far will also be referred to as a “first deposition step”. Along long sides of the negative electrode current collector having a belt shape, an obtained stack had a portion that was not provided with the active material-containing layers or the organic fiber layers. This portion functions as a current-collecting tab after stamping of a negative electrode structure, which is a subsequent step.

Subsequently, in a procedure to be described below, the negative electrode structure described with reference to FIG. 5 as a schematic view was produced. Specifically, on the still unpressed organic fiber layer provided in a belt shape, the central region of the organic fiber layer was masked so that two long sides of the organic fiber layer were exposed. Next, as described with reference to FIG. 12, the organic fiber was further deposited on the exposed portions on the main surface of the organic fiber layer. Processing of depositing, in a state in which a part of the organic fiber layer is masked, the organic fiber layer on another part (exposed portion) of the organic fiber layer after the first deposition step will also be referred to as a “second deposition step”. Thus, for the organic fiber layer that extends in a belt shape, a deposited mass per unit area on the two long sides was increased.

Thereafter, the mask was removed, and as a first pressing step, the whole of the organic fiber layer was sent to a roll press. The obtained stack was stamped so that dimensions of the main surface on a portion excluding the current-collecting tab are 70 mm×90 mm in terms of size, and the negative electrode structure was produced. Herein, the dimensions of the main surface on the portion excluding the current-collecting tab are treated as dimensions of the negative electrode (see Table 1). In Example 1, the second pressing step mentioned above with reference to FIG. 9 and the like is not implemented. Specifically, the press for pressurizing only the portions corresponding to the peripheral edge portions (first regions) of the organic fiber layers is not implemented.

In the obtained negative electrode structure, on both surfaces thereof, as shown in FIG. 5, the first regions 11 are provided on two sides facing each other, the two sides including the side from which the current-collecting tab 3c protrudes. A density of the first regions 11, which was measured by the method described in the first embodiment, was 0.55 g/cm³. Meanwhile, a density of the second region 12, which was measured by the method described in the first embodiment, was 0.35 g/cm³. Further, both of the first organic fiber that constituted the first regions 11 and the second organic fiber that constituted the second region 12 were polyamideimide. Both of average diameters of the first organic fiber and the second organic fiber were 1.1 μm.

A plurality of the negative electrode structures obtained by the above-described method were produced.

(Formation of Insulating Particle Layer)

Next, insulating particle layers were formed on the positive electrode. Specifically, first, solid electrolyte particles LATP (Li₂O—Al₂O₃—SiO₂—P₂O₅—TiO₂), carboxymethylcellulose, styrene butadiene rubber, and water were mixed together, and slurry was prepared. A mass ratio of the LATP, the carboxymethylcellulose, and the styrene butadiene rubber was 100:1:1. Subsequently, the slurry was applied by a microgravure method on the positive electrode active material-containing layers provided on both surfaces of the positive electrode current collector. Coating films were dried to remove the solvent, whereby the insulating particle layers were formed. An average film thickness of the insulating particle layers was approximately 3 μm. On each of both surfaces of the obtained positive electrode, the positive electrode active material-containing layer and the insulating particle layer stacked thereon were provided.

The positive electrode thus obtained was stamped so that dimensions of a main surface on a portion excluding the current-collecting tab were 65 mm×85 mm in terms of size, and a counter electrode structure (positive electrode structure) was produced. Herein, the dimensions of the main surface on the portion excluding the current-collecting tab are treated as dimensions of the positive electrode (see Table 1). The counter electrode structure does not have the organic fiber layer.

A plurality of the positive electrode structures obtained by the above-described method were produced.

(Preparation of Nonaqueous Electrolyte) Electrolyte salt was dissolved into an organic solvent, and a liquid nonaqueous electrolyte was obtained. As the electrolyte salt, LiPF₆ was used. A molar concentration of the LiPF₆ in the nonaqueous electrolyte was set to 12 mol/L. As the organic solvent, a mixed solvent of propylene carbonate (PC) and diethyl carbonate (DEC) was used. A volume ratio of the PC and the DEC was 1:2.

(Production of Secondary Battery)

The plurality of negative electrode structures and the plurality of positive electrode structures, which were produced previously, were stacked alternately with each other, and an electrode group was produced. At this time, the negative electrode structures and the positive electrode structures were stacked so that edge portions of the insulating particle layers provided in the positive electrode structures came into contact with first regions of the organic fiber layers provided in the negative electrode structures. The obtained electrode group was housed in a pack formed of a laminated film with a thickness of 0.1 mm, the laminated film being formed of aluminum foil with a thickness of 40 μm and of polypropylene layers formed on both surfaces of the aluminum foil, and was subjected to vacuum drying at 120° C. for 24 hours. Thereafter, the above-described nonaqueous electrolyte was injected into such a laminated film pack that houses the electrode group therein, and thereafter, the pack was completely sealed by heat sealing, and a secondary battery was produced.

### Example 2

A secondary battery was produced in the same manner as in Example 1 except that the dimensions of main surfaces of positive and negative electrodes were set the same. At the time of stacking the plurality of negative electrode structures and the plurality of positive electrode structures alternately with each other, both thereof were stacked so that edge portions of the positive electrode structures and edge portions of the negative electrode structures came into contact with each other.

### Example 3

A secondary battery was produced in the same manner as in Example 1 except that, at the time of producing the negative electrode structures, the pressing process method was changed to produce such negative electrode structures having the structure shown in FIG. 1 shown as a schematic view. That is, in each of the negative electrode structures according to Example 3, the first region was provided so that the peripheral edge portion on the main surface of the active material-containing layer was coated with the first region.

### Example 4

At the time of producing the negative electrode structures, the pressing process method was changed to provide the first regions on two sides facing each other, the two sides not including the side from which the current-collecting tab protrudes. A secondary battery was produced in the same manner as in Example 1 except for the above.

(Examples 5 and 6)

Secondary batteries were produced in the same manner as in Example 1 except that, at the time of the second deposition step, a range of the organic fiber layer, which was to be masked, was changed to change the widths of the first region and the second region as shown in Table 1.

### Example 7

A secondary battery was produced in the same manner as in Example 1 except that the second deposition step was omitted to equalize the mass per unit area M1 of the first region and the mass per unit area M2 of the second region to each other.

Specifically, at the time of producing the organic fiber layer, the first deposition step was performed, and thereafter, the pressing step (first pressing step) of pressuring the entire surface of the organic fiber layer was implemented. Thereafter, the second deposition step was not performed, but the pressing step (second pressing step) in which only the portion of the organic fiber layer, which corresponded to the first region, was pressurized was performed.

### Example 8

A secondary battery was produced in the same manner as in Example 1 except that, at the time of the second deposition step, the mass per unit area M1 of the first region was increased up to 2.7 g/cm².

### Example 9

A secondary battery was produced in the same manner as in Example 1 except that, at the time of forming the organic fiber layer on the negative electrode, polyimide was used as the organic material.

### Example 10

In Example 10, a secondary battery was produced in the same manner as in Example 1 except that the winding-type electrode group was produced instead of the stacking-type electrode group in a procedure to be described below.

First, in the same manner as described in Example 1, a negative electrode active material-containing layer was provided on a belt-shaped current collector, and thereafter, the first deposition step was implemented, and an organic fiber layer was deposited. Next, the surface of the organic fiber layer was masked so that a long side from which the negative electrode tab did not protrude was exposed. In a state in which a part of the organic fiber layer was masked as described above, the second deposition step was implemented for only the exposed long side (side from which the tab did not protrude) to further deposit the organic fiber layer, and a stack was obtained. By this deposition, the organic fiber layer was also deposited on the side surface of the negative electrode current collector and the side surface of the negative electrode active material-containing layer. This stack included such negative electrode active material-containing layers and such organic fiber layers on both surfaces of the negative electrode current collector. Thereafter, the mask was removed, and as the first pressing step, both surfaces of the stack were sent to the roll press. In this way, the negative electrode structure described with reference to FIGS. 16 and 17 was produced. In the produced negative electrode structure, the first region in the organic fiber layer extending in a long belt shape was formed along the long side from which the negative electrode tab did not protrude.

Separately, a belt-shaped positive electrode structure was produced in the same manner as in Example 1.

As shown in FIGS. 16 and 17, the produced negative electrode structure and the produced positive electrode structure were stacked while being shifted from each other so that the negative electrode current-collecting tab and the positive electrode current-collecting tab protruded in directions opposite to each other, and these are wound, whereby such a winding-type electrode group was produced.

### Comparative Example 1

A secondary battery was produced in the same manner as in Example 1 except that the second deposition step was not performed.

### Comparative Example 2

A secondary battery was produced in the same manner as in Example 1 except for contents to be described later.

A deposition amount of the organic fiber in the first deposition step was increased, and the mass per unit area M1 of the first region and the mass per unit area M2 of the second region were increased as shown in Table 2.

Meanwhile, the pressing pressure in the first pressing step was increased, and the film thickness of the organic fiber layer, that is, the film thickness T1 of the first region and the film thickness T2 of the second region were set to the same extent to those in Example 1.

### Comparative Example 3

A secondary battery was produced in the same manner as in Example 10 except that the second deposition step was not performed.

### Comparative Example 4

At the time of producing the organic fiber layer, the average diameter of the first organic fiber included in the position corresponding to the first region was increased more than the average diameter of the second organic fiber included in the position corresponding to the second region. Specifically, the average diameter of the first organic fiber was set to 2.1 μm, and the average diameter of the second organic fiber was set to 1.1 μm. A secondary battery was produced in the same manner as in Comparative example 1 except for the above-described matter.

<Measurement of Self-Discharge Amount>

First, under a temperature environment of 25° C., each of the secondary batteries was charged until a state of charge (SOC) thereof reached 100%, and thereafter, was discharged until the SOC reached 0%. Next, the already discharged battery was charged so that the SOC reached 50%, and a battery voltage immediately after the charge was measured by using a tester. The battery voltage at this time was set to an initial voltage V. Subsequently, this battery was left standing at room temperature for one day, and thereafter, the battery voltage was measured by using a tester. The battery voltage at this time was set to Vl. This battery was left standing for another two days (three days in total), and thereafter, the battery voltage was measured by using a tester. The battery voltage at this time was set to V3.

The battery voltage V3 is subtracted from V1, whereby a reduced voltage ΔV is calculated, which is regarded as a self-discharge amount. In the column of “Self-discharge amount (ratio)” in the following Table 2, ratios of the self-discharge amounts in the respective examples with respect to the self-discharge amount according to Comparative example 1, which is defined as 1, are shown.

Hence, lower numeric values in the respective examples mean higher performance for suppressing the self-discharge.

<Measurement of Resistance>

First, under a temperature environment of 25° C., each of the secondary batteries was charged at a charge rate 1 C (a current value at which the SOC reaches 0% for one hour when a battery is discharged from the SOC 100%) until the SOC reached 100%, and was discharged at a discharge rate 1 C until the SOC reached 50%, and a charge depth thereof was adjusted. Thereafter, the battery was discharged at 10 C for 10 seconds, and an internal resistance (resistance value) thereof was obtained from a change of the voltage and a current value for 10 seconds.

In the column of “Resistance value (ratio)” in the following Table 2, ratios of the resistance values in the respective examples with respect to the resistance value according to Comparative example 1, which is defined as 1, are shown. Hence, lower numeric values in the respective examples mean lower resistances of the secondary batteries.

<Measurement of Film Thickness, Mass Per Amount, and Density of Organic Fiber Layer>

In accordance with the measurement method described in the first embodiment, the film thicknesses, masses per unit area, and densities of the organic fiber layers provided in the negative electrode structures provided in the respective secondary batteries were measured.

Results of the above are summarized in the following Tables 1 and 2. In Table 1, in the column of “Self-discharge amount ratio*resistance value ratio”, numeric values obtained by multiplying values of “Self-discharge amount (ratio)” and “Resistance value (ratio)” by each other are shown. Lower values of the “Self-discharge amount ratio*resistance value ratio”, indicate that both of the resistance reduction and the self-discharge suppression can be achieved.

TABLE 1

| | Width (mm) | | | | | | |
|---|---|---|---|---|---|---|---|
| | | | | | First | | |
| | | | | | region | | |
| | | | | | (totally | | |
| | Positive | Negative | Organic | Second | both | Present position | Organic fiber |
| | electrode | electrode | fiber layer | region | sides) | of first region | layer material |
| Example 1 | 85 | 90 | 90 | 70 | 20 | Facing two sides | Polyamideimide |
| | | | | | | including side with tab | |
| Example 2 | 85 | 85 | 85 | 65 | 20 | Facing two sides | Polyamideimide |
| | | | | | | including side with tab | |
| Example 3 | 85 | 90 | 90 | 70 | 20 | All of four sides of | Polyamideimide |
| | | | | | | organic fiber layer | |
| Example 4 | 85 | 90 | 90 | 70 | 20 | Facing two sides | Polyamideimide |
| | | | | | | including side without tab | |
| Example 5 | 85 | 90 | 90 | 65 | 25 | Facing two sides | Polyamideimide |
| | | | | | | including side with tab | |
| Example 6 | 85 | 90 | 90 | 75 | 15 | Facing two sides | Polyamideimide |
| | | | | | | including side with tab | |
| Example 7 | 85 | 90 | 90 | 70 | 20 | Facing two sides | Polyamideimide |
| | | | | | | including side with tab | |
| Example 8 | 85 | 90 | 90 | 70 | 20 | Facing two sides | Polyamideimide |
| | | | | | | including side with tab | |
| Example 9 | 85 | 90 | 90 | 70 | 20 | Facing two sides | Polyimide |
| | | | | | | including side with tab | |
| Example 10 | 85 | 90 | 90 | 70 | 20 | Only side without tab | Polyamideimide |
| | | | | | | (winding-type | |
| | | | | | | electrode group) | |
| Comparative | 85 | 90 | 90 | — | — | Facing two sides | Polyamideimide |
| example 1 | | | | | | including side with tab | |
| Comparative | 85 | 90 | 90 | — | — | Facing two sides | Polyamideimide |
| example 2 | | | | | | including side with tab | |
| Comparative | 85 | 90 | 90 | — | — | Only side without tab | Polyamideimide |
| example 3 | | | | | | (winding-type | |
| | | | | | | electrode group) | |
| Comparative | 85 | 90 | 90 | — | — | Facing two sides | Polyamideimide |
| example 4 | | | | | | including side with tab | |

TABLE 2

| | | | | | | | | | | | | Self- |
|---|---|---|---|---|---|---|---|---|---|---|---|---|
| | | | | Film | | | Mass per | | | | | discharge |
| | Density | | | thickness | | | unit area | | | | | amount |
| | (g/cm³) | | | (μm) | | Film | (g/cm²) | | Ratio of | Self- | | ratio* |
| | Second | First | Density | Second | First | thickness | Second | First | mass per | discharge | Resistance | resistance |
| | region | region | ratio | region | region | ratio | region | region | unit area | amount | value | value |
| | (D2) | (D1) | D1/D2 | (T2) | (T1) | T1/T2 | (M2) | (Ml) | M1/M2 | (ratio) | (ratio) | ratio |
| Example 1 | 0.35 | 0.55 | 1.6 | 3.9 | 4.1 | 1.1 | 1.4 | 2.3 | 1.7 | 0.21 | 1.1 | 0.23 |
| Example 2 | 0.35 | 0.55 | 1.6 | 3.9 | 4.1 | 1.1 | 1.4 | 2.3 | 1.7 | 0.26 | 1.1 | 0.29 |
| Example 3 | 0.35 | 0.55 | 1.6 | 3.9 | 4.1 | 1.1 | 1.4 | 2.3 | 1.7 | 0.11 | 1.3 | 0.14 |
| Example 4 | 0.35 | 0.55 | 1.6 | 3.9 | 4.1 | 1.1 | 1.4 | 2.3 | 1.7 | 0.26 | 1.2 | 0.32 |
| Example 5 | 0.35 | 0.55 | 1.6 | 3.9 | 4.1 | 1.1 | 1.4 | 2.3 | 1.6 | 0.21 | 1.4 | 0.29 |
| Example 6 | 0.35 | 0.55 | 1.6 | 3.9 | 4.1 | 1.1 | 1.4 | 2.3 | 1.6 | 0.26 | 1.0 | 0.26 |
| Example 7 | 0.35 | 0.55 | 1.6 | 3.9 | 2.5 | 0.6 | 1.4 | 1.4 | 1.0 | 0.26 | 1.1 | 0.29 |
| Example 8 | 0.33 | 0.68 | 2.0 | 4.1 | 4.0 | 1.0 | 1.4 | 2.7 | 2.0 | 0.16 | 1.4 | 0.22 |
| Example 9 | 0.40 | 0.61 | 1.5 | 4.2 | 4.1 | 1.0 | 1.7 | 2.5 | 1.5 | 0.16 | 1.3 | 0.21 |
| Example 10 | 0.36 | 0.55 | 1.5 | 3.9 | 4.1 | 1.1 | 1.4 | 1.4 | 1.0 | 0.21 | 1.2 | 0.25 |
| Comparative | 0.35 | 0.35 | 1.0 | 4.1 | 4.0 | 1.0 | 1.4 | 1.4 | 1.0 | 1.00 | 1.0 | 1.00 |
| example 1 | | | | | | | | | | | | |
| Comparative | 0.56 | 0.56 | 1.0 | 4.0 | 3.9 | 1.0 | 2.2 | 2.2 | 1.0 | 0.16 | 2.3 | 0.36 |
| example 2 | | | | | | | | | | | | |
| Comparative | 0.35 | 0.33 | 1.0 | 4.0 | 4.2 | 1.1 | 1.4 | 1.4 | 1.0 | 0.68 | 1.1 | 0.75 |
| example 3 | | | | | | | | | | | | |
| Comparative | 0.34 | 0.34 | 1.0 | 4.1 | 4.1 | 1.0 | 1.4 | 1.4 | 1.0 | 0.53 | 1.1 | 0.58 |
| example 4 | | | | | | | | | | | | |

From Tables 1 and 2, for example, the following is readable.

It is seen that, as shown in each of Examples 1 to 10, when the density D1 of the first region of the organic fiber layer was higher than the density D2 of the second region thereof, a secondary battery with lower resistance and self-discharge suppressed more than those of Comparative examples 1 to 4 was obtained.

It is seen that, as shown in Example 3, when the first region is present in a frame shape on four sides excluding the current-collecting tab, the reduction of the resistance and the suppression of the self-discharge can be achieved in a good balance. It is considered that, since the first region is provided at the position of four sides which constitute the outline of the active material-containing layer, the peel off and the like of the organic fiber layer on the electrode edge portion are suppressed.

Also in each of Example 7 in which the film thickness was greatly differentiated between the first region and the second region, and of Example 8 in which the mass per unit area was greatly differentiated between the first region and the second region, the secondary battery with low resistance and suppressed self-discharge was obtained. When Example 7 and Example 1 are compared with each other, it is seen that the self-discharge amount tends to be able to be reduced by increasing, to more than 1.0, the ratio M1/M2 of the mass per unit area M1 of the first region and the mass per unit area M2 of the second region.

As apparent from Example 9, it is seen that, even if polyimide was used as an organic material that constituted the organic fiber layer, the secondary battery with low resistance and suppressed self-discharge was obtained.

In the case of Comparative example 1, at the time of stamping the electrode including the organic fiber layer, the organic fiber layer on the peripheral edge portion was peeled off, and the peeled-off spot and the counter electrode came into contact with each other to cause an internal short circuit, and therefore, the self-discharge amount was significantly large.

In the case of Comparative example 2, the mass per unit area was large in each of the first region and the second region, and the density in each of the regions was a value as high as 0.56 g/cm³. Therefore, the self-discharge amount was able to be suppressed to be low. However, the density D2 of the second region that was a main ion conduction path between the positive and negative electrodes was substantially the same as the density D1 of the first region. Accordingly, the ion conduction was likely to be inhibited, and a high resistance value was exhibited.

As shown in Example 10, even if the electrode group was of a winding type, such a secondary battery with low resistance and suppressed self-discharge was obtained. In the negative electrode structure according to Example 10, the first region was provided on the long side that did not include the tab, and therefore, a breakage of the electrode on the long side, for example, a breakage of the active material-containing layer and the current-collecting foil was able to be suppressed. As a result, the self-discharge amount was able to be suppressed to be low. In contrast, in Comparative example 3, the first region was not provided on the long side that did not include the tab, that is, the density D1 of the first region was not higher than the density D2 of the second region. Therefore, an electrode breakage occurred, and the self-discharge increased.

As shown in Comparative example 4, when the average diameter of the first organic fiber was increased, the contact area between the first organic fiber and the active material-containing layer in the first region increased, and therefore, it was observed that the peel strength of the organic fiber layer in the first region tended to be enhanced. That is, in Comparative example 4, the peel off and the like in the peripheral edge portion (electrode edge portion) of the organic fiber layer was able to be suppressed. However, the self-discharge amount increased since the first region and the second region had the same density. This is considered to be because the first region became coarse since the average diameter of the first organic fiber was large.

In accordance with at least one of the above-mentioned embodiments and examples, an electrode structure is provided. The electrode structure includes: the current collector; the active material-containing layer provided on at least one surface of the current collector; and the organic fiber layer provided on the active material-containing layer. The organic fiber layer includes: the first region facing the active material-containing layer; and the second region adjacent to the first region, present on the center side of the main surface of the organic fiber layer, and facing the active material-containing layer. The outer edge of the first region included in the organic fiber layer overlaps the outline of the main surface of the active material-containing layer along the stack direction of the active material-containing layer and the organic fiber layer. The density D1 of the first region of the organic fiber layer is higher than the density D2 of the second region of the organic fiber layer.

The organic fiber layer is excellent in adhesion to the active material-containing layer in the first region, and therefore, can suppress the peel off of the organic fiber layer in the electrode edge portion. Further, the second region of the organic fiber layer is less likely to inhibit the ion conduction. Hence, the electrode structure according to the embodiment is capable of achieving the secondary battery with low resistance and suppressed self-discharge.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electrode structure comprising:
a current collector comprising a current-collecting tab;
an active material-containing layer provided on at least one surface of the current collector; and
an organic fiber layer provided on the active material-containing layer, wherein
the organic fiber layer comprises: a first region facing the active material-containing layer; and a second region adjacent to the first region, present on a center side of a main surface of the organic fiber layer, and facing the active material-containing layer,
an outer edge of the first region comprised in the organic fiber layer overlaps an outline of a main surface of the active material-containing layer along a stack direction of the active material-containing layer and the organic fiber layer, and
a density D1 of the first region of the organic fiber layer is higher than a density D2 of the second region of the organic fiber layer.

2. The electrode structure according to claim 1, wherein
the outline of the active material-containing layer and the outer edge of the first region comprised in the organic fiber layer are both rectangular, and
the first region is provided at positions corresponding to four sides of the rectangles.

3. The electrode structure according to claim 1, wherein
the outline of the active material-containing layer and the outer edge of the first region comprised in the organic fiber layer are both rectangular, and
the first region is provided at positions comprising two sides facing each other, the two sides belonging to four sides which constitute the outline of the active material-containing layer corresponding to the rectangles.

4. The electrode structure according to claim 3, wherein
the current-collecting tab is provided to protrude from one side among the four sides which constitute the rectangle that is the outline of the active material-containing layer, and
the first region is provided at positions comprising two sides facing each other, the two sides comprising a side from which the current-collecting tab protrudes.

5. The electrode structure according to claim 1, wherein the density D1 of the first region is in a range of 0.40 g/cm³ and 0.80 g/cm³.

6. The electrode structure according to claim 1, wherein the density D2 of the second region is in a range of 0.30 g/cm³ and 0.60 g/cm³.

7. The electrode structure according to claim 1, wherein a ratio T1/T2 of a thickness T1 of the first region with respect to a thickness T2 of the second region is in a range of 0.3 to 1.1.

8. The electrode structure according to claim 1, where a ratio M1/M2 of a mass per unit area M1 of the first region with respect to a mass per unit area M2 of the second region is in a range of 0.5 to 3.0.

9. The electrode structure according to claim 1, wherein the ratio T1/T2 of the thickness T1 of the first region with respect to the thickness T2 of the second region is in a range of 0.90 to 1.1, and
the ratio M1/M2 of the mass per unit area M1 of the first region with respect to the mass per unit area M2 of the second region is in a range of larger than 1.0 and 2.0 or less.

10. The electrode structure according to claim 1, wherein
the first region comprises first organic fiber,
the second region comprises second organic fiber, and
each of the first organic fiber and the second organic fiber comprises at least one organic material selected from the group consisting of polyamideimide, polyamide, polyolefin, polyether, polyimide, polyketone, polysulfone, cellulose, polyvinyl alcohol, and polyvinylidenefluoride.

11. A secondary battery comprising:
the electrode structure according to claim 1,
a counter electrode that faces the electrode structure; and
an electrolyte.

12. A battery pack comprising the secondary battery according to claim 11.

13. The battery pack according to claim 12, further comprising:
an external power distribution terminal; and
a protective circuit.

14. The battery pack according to claim 12, comprising a plurality of the secondary battery, wherein
the secondary batteries are electrically connected in series or parallel to one another, or in series and parallel to one another.

15. A vehicle comprising the battery pack according to claim 12.

16. The vehicle according to claim 15, comprising a mechanism configured to convert kinetic energy of the vehicle to regenerative energy.
